(19) United States
(12) Patent Application Publication
(10) Pub. No.: US 2006/0159099 A1
(43) Pub. Date: Jul. 20, 2006

(54) Videoconferencing device and system

(76) Inventor: Steven Mack Hensley, Vancouver, WA (US)

Correspondence Address: JUNEAU PARTNERS, P.O. BOX 2516, ALEXANDRIA, VA, 22301, US

(21) Appl. No.: 11/222,965

(22) Filed: Sep. 12, 2005

Related U.S. Application Data
(60) Provisional application No. 60/614,594, filed on Oct. 1, 2004.
(60) Provisional application No. 60/614,544, filed on Oct. 1, 2004.
(60) Provisional application No. 60/614,543, filed on Oct. 1, 2004.
(60) Provisional application No. 60/614,591, filed on Oct. 1, 2004.

(51) Int. Cl. H04L 12/56

(52) U.S. Cl. 370/395.1

(57) ABSTRACT

The invention comprises a bridgeless multi-way videoconferencing system with a number of high quality advanced features. It is connected at the customer's conference room or video site to a high-resolution pan, zoom and tilt video camera; wireless mouse; video monitor or a standard TV; stereo speakers and a microphone. It is also connected to VideoPresence switches, billing and provisioning systems. The local connection is a standard T1 or E1 and the backbone connections between the VideoPresence switches located in U.S. and international markets are DS3, OC3 or larger circuits.

### CROSS REFERENCE TO RELATED APPLICATIONS

This application claims the benefit under 35 U.S.C. 119(e) to U.S. Provisional 60/614,594 filed Oct. 1, 2004, U.S. Provisional 60/614,544 filed Oct. 1, 2004, U.S. Provisional 60/614,543, filed Oct. 1, 2004, and U.S. Provisional 60/614,591, filed Oct. 1, 2004.

### FIELD OF THE INVENTION

The invention relates to videoconferencing and, specifically to a device and system for providing TV-quality multi-way and unlimited multicast videoconferencing to client locations over local T1 and E1 connections and DS3, OC1 and OC3 backbone circuits.

### DESCRIPTION OF THE PRIOR ART

Today, the competitive videoconferencing landscape includes equipment vendors that have no control over the price and quality of network services; managed service providers that provide technical management solutions for videoconferencing customers; and carriers who provide connectivity, bridging and gateway services but have no control over the quality and price of end-point equipment. Accordingly, demand for managed services is strong because competitive videoconferencing systems require extensive technical knowledge to set up and install network of systems; it takes technical skills to set up and manage a group video call with today's competitive systems. In addition, it can be argued that 3rd party bridging services represent a major portion of overall managed services because competitive systems have limited multi-way capabilities and the price of MCUs (multi-way control units) is very high.

There is a need for high quality and easy to use group videoconferencing equipment. The majority of the legacy systems are configured for 384K-ISDN connectivity. Less than 2% of the group videoconferencing systems sold today employ high resolution compression technology, such as MPEG4 or better. Today, premium group videoconferencing systems are also configured for IP, PRI and ATM connections. Video over IP systems require about 50% more bandwidth to achieve the same level of video quality, relative to a specific. CODEC technology. Almost all of today's videoconferencing systems are “standards' based.” The video standard H.263, for example, was originally designed for low bit rate communication, such as data rates less than 64 Kbits/s (the same bit rate used for a phone call); but today it is used for a wide range of bit rate applications. H.264 is a standard that represents an improvement in performance and error recovery over H.263 and H.261. H.263 and H.264 support five video resolutions:

TABLE:

| Picture Format | Luminance Pixels | Scan Lines |
|---|---|---|
| SQCIF | 128 | 96 |
| QCIF | 176 | 144 |
| CIF | 352 | 288 |
| 4CIF | 704 | 576 |
| 16CIF | 1408 | 1152 |

Other standards typically found with competitive product literature include H.320 (allows ISDN BRI videoconferencing systems to communicate with each other); H.323 (channel set up and codec specifications for transmitting real-time voice and video over networks that have quality of service problems, such as IP networks); and G.711, G.722, G.722.1 and G.728 (standards for digital audio). These coding algorithms also give designers options to improve performance, such as forward and backward frame prediction similar to MPEG called P-B frames. Adherence to these common algorithms and design choices has produced a “me-too” industry that sometimes has a hard time differentiating one player from another. One of the goals with the creation of standards was “inter-operability” or the ability of systems produced by different vendors to communicate with each other. Gateways are also used for this purpose. In practice, interoperability is rarely achieved with high levels of quality and reliability with competitive videoconferencing technology solutions. Incredibly this problem holds also is often true for systems produced by the same vendor that utilize the same design standards.

There are other problems as well. The standards are often used as misleading marketing tools. For example, to say that a system can support 4CIF and 16CIF does not necessarily mean that it can produce TV-quality video resolution over a standard T1 or PRI interface. In fact, there does not appear to be any commercial system regardless of bandwidth that can produce 16CIF at 30 frames per second on a NTSC or PAL video or TV monitor. This level of video resolution with competitive systems is actually addressing the video image at very low frame rates (1 to 2 fps) that correspond to the video resolution of a document or a still object. While some very expensive systems may be able to produce 4CIF resolution in certain situations, there does not appear to be any commercial system that can produce a 4CIF video image in a multi-way video call. With competitive systems the quality of the video resolution is typically (QCIF−176×144) or worst most of the time with a multi-way video call.

Further, group videoconferencing systems are costly. Almost all of these systems have a multi-way capability that is limited. External multi-way control units (MCUs) are costly. Multi-way equipment for IP systems typically requires additional equipment, such as routers and gateway systems. Additionally, the use of managed bridging services are also cost prohibitive.

One videoconferencing device known in the art is Polycom's VS4000 PRI with installed multi-point. The Polycom VS4000 Set Top Box connects via PRI digital line or IP network. The embedded multi-point capability enables up to four sites at 384 Kbps or three sites at 512 Kbps on H.320 (ISDN) or H.323 (IP) video calls.

Another videoconferencing device known in the art is Tandberg's 6000 MCU PRI/T1. This unit typically combines cameras, video displays, networking equipment, and software in a bundled package. Tandberg's product connects six video sites in a multiway video call.

Another solution known in the art relates to the emergence of managed services in the videoconferencing industry. This is a direct result of the complexity associated with current technology solutions, including the confusion and difficulty associated with buying, installing, using and maintaining group videoconferencing systems. Not only is it difficult for the end user to determine what to buy or how to set up and manage a video call, particularly a multi-way video call, it has become overwhelming for many IT managers and administrators as well. It is estimated that 80 percent of the video conferencing applications are run in-house or as customer-managed applications. Managed Service Providers (MSPs) have been positioning themselves to manage customer networks and applications. In addition to selling expertise (on or off-site), some MSPs provide bridging or multi-way services; others also resell equipment and network connectivity. The carriers that provide managed services, such as AT&T, Global Crossing, MCI and Sprint, are seeking to leverage their network infrastructures often with some variation of a converged voice, data and video network access, bridging and gateway service.

However, MSPs are also costly per end point for installation; hourly, monthly or fixed charges per end point for technology management are prohibitive; conference management is costly; bridging services are expensive and charged per hour per video site; and video over IP for T1 access can incur monthly costs per site.

Another solution in this field relates to “web conferencing”. World Web Conferencing is defined here as those services and software solutions that deliver an Internet-based, real-time, group meeting environment that can be utilized for presentation and/or collaboration applications.

There has been a great deal of interest and promises over the last couple of years of “true

convergence” of audio, data and video conferencing. In reality, the market is just beginning to see the first signs of rich media conferencing being delivered to the end users' desktops. Currently, many convergence efforts are focused on unifying audio and data conferencing into a single application or user console, and desktop videoconferencing is the next big stage of integration. The industry, therefore, is providing solutions for an ad-hoc virtual conference room that enables full audio control, while also providing the ability to share data. This level of convergence is mostly taking place at the desktop and not as a completely converged infrastructure or set of converged back-end technologies. Today, the web conferencing industry is focused on developing and selling a collaborative suite of applications, such as VoIP, video over IP, instant messaging, presence portals, document management, calendaring and email tools. These converging pieces of the collaboration mosaic exist today as separate communication practices or business silos.

Additionally, patents in the general field of videoconferencing include the following.

Spiegel et al, U.S. Pat. No. 6,862,284 ('284), assigned to Cisco, entitled “Format for automatic generation of unique ATM addresses used for PNNI” discloses a method and system for providing unique ATM End System Addresses, in which each new device is assigned a unique address in an ATM network while allowing all new devices performing the PNNI protocol in a selected set (such as all those from a single manufacturer) to be assigned by default to the same peer group.

Igarashi et al., U.S. Pat. No. 6,836,464, assigned to NEC, entitled “PNNI routing computation system in ATM exchange” discloses a PNNI routing computation system, wherein each ATM exchange stores plural types of weight values for computing route for each link and stores a type which a subscriber uses for routing.

Trebes, Jr., U.S. Pat. No. 6,788,688, unassigned to a company, entitled “System and method for providing peer-oriented control of telecommunications services” discloses in a telecommunications network environment including non-participating elements and participating elements, a method for providing a telecommunications service between a first peer element connected to the telecommunications network environment and a second peer element connected to the telecommunications network.

Shirakawa, U.S. Pat. No. 6,781,952, assigned to NEC, entitled “Establishment of designated S-PVC connection in PNNI operation ATM switching apparatus network” discloses establishing an S-PVC (soft private virtual connection) connection in a PNNI (private network-network interface) network of a plurality of peer groups, each of which includes at least an ATM (asynchronous transfer mode) switching apparatus as an ATM node, a first identifier and first designated route data associated with the S-PVC channel are set in each of the plurality of peer groups.

Allen, Jr. et al., U.S. Pat. No. 6,765,903, assigned to SBC Technology Resources, entitled “ATM-based distributed network switching system” discloses an Asynchronous Transfer Mode (ATM)-based distributed network switching system includes an ATM switching network that dynamically sets up individual switched virtual connections.

Bi et al., U.S. Pat. No. 6,757,278, assigned to SBC Technology Resources, entitled “Secure ATM-based distributed virtual tandem switching system and method” discloses a system and method for ensuring security in a voice trunking over ATM (VTOA) environment is provided. A telecommunications network is provided that carries control traffic and bearer traffic via ATM communications channels and TDM communications channels.

Takihiro et al., U.S. Pat. No. 6,700,874, assigned to Hitachi, entitled “Network system having route verification function and the component apparatuses and method thereof” discloses Switches that create and manage routes with route control protocols such as BGP-4, PNNI, etc. and a route management apparatus is notified of the information of the routes, created by these protocols, and the route management apparatus verifies the validity of a route of which the apparatus is notified by a switch based on the route information of the whole network composed of the plurality of pieces of information given by respective switches and the management policy set by a network manager.

Brown, U.S. Pat. No. 6,678,273, assigned to Semaphore, entitled “Managed Private Network System”, discloses a managed private network (“MPN”) system for interconnecting enterprise entities to subscriber entities.

Cable et al., U.S. Pat. No. 6,549,530, assigned to Nortel Networks, entitled “Integrated signalling for asynchronous networks” discloses a multiple access asynchronous network segment for providing network access to a plurality of end systems over a shared medium uplink to a satellite headend supported by a network controller, wherein the network controller allocates part of the uplink resource and the satellite headend allocates part of the uplink resource on a temporary basis in response to end systems making a new request for uplink resource.

Margulis et al., U.S. Pat. No. 6,493,345, assigned to 3COM, entitled “Single sender private multicast server for use with LAN emulation in asynchronous transfer mode networks” discloses a system comprising a single sender SMS for forwarding multicast traffic is collocated in the same device as the LEC thus creating an optimal distribution path for multicast traffic.

Allen, Jr. et al, U.S. Pat. No. 6,389,011, assigned to SBC Technology Resources, entitled “ATM-based distributed virtual tandem switching system” discloses an Asynchronous Transfer Mode (ATM)-based distributed virtual tandem switching system is provided in which a network of ATM-based devices is combined to create a distributed virtual tandem switch.

Allen, Jr., et al., U.S. Pat. No. 6,345,048 ('048), assigned to SBC Technology Resources, entitled “ATM-based distributed virtual tandem switching system” discloses an Asynchronous Transfer Mode (ATM)-based distributed virtual tandem switching system is provided in which a network of ATM-based devices is combined to create a distributed virtual tandem switch.

Crawley et al., U.S. Pat. No. 6,321,270, assigned to Nortel Networks, entitled “Method and apparatus for multicast routing in a network” discloses a system provided for controlling a multicast session in a network having multiple network nodes.

Rochberger et al., U.S. Pat. No. 6,310,877, assigned to 3COM, entitled “Method of connectionless message transfer in an asynchronous transfer mode network” discloses a method of transferring relatively short messages in an Asynchronous Transfer Mode network utilizing an emulated connectionless oriented technique.

Dugan et al., U.S. Pat. No. 6,078,586, assigned to MCI, entitled “ATM virtual private networks” discloses a network architecture and service platform for providing virtual private network services (“VPN”) over an ATM network.

Chen et al., U.S. Pat. No. 5,946,316, assigned to Lucent, entitled “Dynamic distributed multicast routing protocol” discloses the distribution of multicast information in a communications network formed from a plurality of communications nodes, e.g., ATM switches, is enhanced by providing an efficient mechanism for routing a request to join a multicast connection to an originator of the multicast and an efficient mechanism for then connecting the requester to the multicast connection.

Crawley et al., U.S. Pat. No. 5,881,246, assigned to Bay Networks, entitled “System for generating explicit routing advertisements to specify a selected path through a connectionless network to a destination by a specific router” discloses a system for providing explicit routing functions in a connectionless network.

Liang, et al., U.S. Pat. No. 5,781,529, assigned to General DataComm, entitled “Systems and methods for routing ATM switched virtual circuit calls” discloses an invention that routes SVC ATM call setups by utilizing one of a plurality of designated transit lists (DTLs) stored at an originating node.

Tompkins et al., U.S. Pat. No. 5,014,267, assigned to Datapoint, entitled “Video conferencing network” discloses a video conferencing network for providing videos, audio, and data communication between remote video terminals.

Faye, U.S. Pat. No. 4,805,205, unassigned, entitled “Method and device for establishing bidirectional communications between persons located at different geographically distant stations” discloses a method and a device for establishing communication between several persons distant from one another.

Addeo et al., U.S. Pat. No. 5,280,540, assigned to Bell Communications Research, entitled “Video teleconferencing system employing aspect ratio transformation” discloses a teleconferencing system that provides a wide aspect ratio view at each site utilizing a single NTSC camera and projector.

Gregory, III, et al., U.S. Pat. No. 5,793,415, assigned to ImageTel International, entitled “Videoconferencing and multimedia system” discloses a videoconferencing system provided which comprises a personal computer having a 32-bit multi-tasking, native-networking operating system and a touch screen graphic user interface for controlling the system.

Tanoi, U.S. Pat. No. 6,211,902, assigned to NEC, entitled “Video conference control apparatus, video conference control method, and video conference control system” discloses a video conference control apparatus includes a decoding circuit, a thinning circuit, an image synthesizing circuit, an encoding circuit, and an encoding area setting circuit.

Addeo et al., U.S. Pat. No. 5,335,011, assigned to Bell Communications Research, entitled “Sound localization system for teleconferencing using self-steering microphone arrays” discloses a teleconferencing system disclosed having a video camera for generating a video signal representative of a video image of a first station B.

Kondo, U.S. Pat. No. 6,037,970, assigned to Sony, entitled “Videoconference system and method therefor” discloses a videoconference system that holds a videoconference among N (a plurality of) communication centers connected by a communication line.

Duttweiler et al., U.S. Pat. No. 5,818,514, assigned to Lucent Technologies, entitled “Video conferencing system and method for providing enhanced interactive communication” discloses a system and method for enhancing interactive communication between video conferencing devices of the type in which a delay is inserted into the audio transmission path to provide lip synchronization of the image and speech of the respective users thereof.

Ely et al., U.S. Pat. No. 5,796,424, assigned to Bell Communications Research, entitled “System and method for providing videoconferencing services” discloses a broadband system that includes a broadband switch network, a broadband session controller, and a broadband service control point.

Vooi-Kia et al., U.S. Pat. No. 6,559,881, assigned to Nokia, entitled “Video telecommunications device, and camera for same” discloses a video telecommunications device and a camera unit for a video telecommunications device.

Kohda et al., U.S. Pat. No. 5,675,374, assigned to Fujitsu, entitled “Video teleconferencing system” discloses a video teleconferencing system adapted to make a video conference among a plurality of participants located at different work locations.

Dermler et al., U.S. Pat. No. 6,509,925, assigned to IBM, entitled “Conferencing System” discloses a distributed multipoint conferencing system (3) that comprises a plurality of participating terminals (31; 32; 33) for sending and receiving media streams in a conferencing interchange; the system further includes at least one multipoint distributor (30) (MD) connected to one terminal (31) for receiving at least one or all media streams from that terminal (31) but not from any other of the participating (32; 33); the multipoint distributor (30) is connected to the other participating terminals (32; 33) for sending the media stream or streams received from the MD-associated terminal (31) to the other participating terminals (32; 33).

Buchner et al., U.S. Pat. No. 6,624,841, assigned to France Telecom, entitled “Videoconference system” discloses a video-conferencing system between participants located at distant sites, each site featuring a viewing screen.

### SUMMARY

Accordingly, an apparatus is disclosed for providing private network videoconferencing services for two or more customers, which comprises:

a circuit board having a housing, digital RAM memory, and a power supply connected thereto;

microprocessor switches, connected to the circuit board and having ATM (asynchronous transfer mode) software loaded thereon;

video display apparatus of TV quality operatively connected to the housing circuit board;

video capture apparatus operatively connected to the circuit board;

stereo audio speaker operatively connected to the circuit board;

microphone operatively connected to the circuit board;

one or more input devices operatively connected to the circuit board;

one or more output devices operatively connected to the circuit board;

input and output jacks or ports including a telephone jack, up to nine or ten USB ports, and a T1 communication port; and,

software which provides for the sending and receiving audio and video data, including advanced compression-decompression (CODEC) algorithms and multiplexing-demultiplexing (MUX-DEMUX) algorithms.

The video display apparatus is capable of producing 525 lines per field and 800 pixels per line at 30 frames per second over a T1 connection. Further, in a multi-site video call, hi-resolution video can be changed from one site to another. The invention also provides a combined audio & video chip set that integrates directly into a communication processor (e.g. 8280). Another unique feature is the integration of USB ports and T1 communications ports on the same set

top box (apparatus). Lastly, another featured embodiment includes wherein a software package is loaded (developed) on the microprocessor to collect

processing data depicting the through-put and error status of the set top

box/apparatus.

There is also disclosed a private videoconferencing network system, which comprises:

one or more regionally located network nodes which are Alcatel ATM boxes having ATM switches therein which provide high capacity network links to a plurality of network nodes and a local T1 interface link to two or more remote set-top boxes for the set-up, operation and take-down of a video SVC conference circuit over pre-purchased T1 capacity from a telecommunication carrier company.

There is further disclosed a method of videoconference transmission, which comprises:

a first user initiating a videoconference from their location using a set-top box to wake up a local regional (first) Network ATM switch, identifying a unique private network source address of said caller and a unique private network destination address of a call recipient;

the first Network ATM switch making a temporary circuit to a second regional Network ATM switch, which in turn contacts a second user's Set-Top box with a session code and then hangs up dropping the first private virtual circuit;

the second user making a return call using the second user's Set-Top box back to the first user through the Network Nodes with the session code, creating a virtual circuit from the second user to the first user;

upon receiving the call from the second user, the first user's Set-Top box creates a return virtual circuit back to the second user, establishing two unidirectional virtual circuits and validating the source address and destination address of the videoconference users,

wherein the method of transmission occurs over private bulk capacity lines and wherein the ATM switches are configured to use ATM ‘hashing’ as a security feature.

### BRIEF DESCRIPTION OF THE FIGURES

FIG. 1 is an illustrative network schematic. FIG. 1 shows an example of an embodiment of the network next to a typical network drawing.

FIG. 2 is an illustrative network schematic. FIG. 2 shows a switched virtual circuit and a point to point SVC in a network configuration for multicasting.

FIG. 3 is an illustrative network schematic. FIG. 3 shows a five step process whereby two conferences join.

FIG. 4 is an illustrative network schematic. FIG. 4 shows a three step process of a two-way call setup.

FIG. 5 is an illustrative network schematic. FIG. 5 shows an Example of a three-way call with picture-in-picture and high quality and low quality circuits.

FIG. 6 is an illustrative network schematic. FIG. 6 shows a four-step process for a three way call setup.

FIG. 7 is an illustrative network schematic. FIG. 7 shows a three step process where two conferences separate.

FIG. 8 is page 1 of an overview of an ATM End System Address (AESA), Local AESA Format, and Private Network Addressing.

FIG. 9 is page 2 of an overview of an ATM End System Address (AESA), Local AESA Format, and Private Network Addressing and shows city codes.

FIG. 10 is a tabular representation. FIG. 10 shows a UNI message header.

FIG. 11 is a tabular representation. FIG. 11 shows a UNI Information Element.

FIG. 12 is a graphical depiction and shows how each set top box is identified with a unique MAC address and each MAC is associated with subscriber addresses.

FIG. 13 is a graphic of the United States and shows examples of codes for various regions.

FIG. 14 is a schematic drawing of the Functional Core of the set top box. FIG. 14 shows the connections within an operational set top box having various component parts.

FIG. 15 is an MIB (management information base) block diagram. FIG. 15 shows the operational layout of the motherboard.

FIG. 16 is an MIB Audio Subsystem Block Diagram.

FIG. 17 is a diagram and shows the MIB Main Hierarchy.

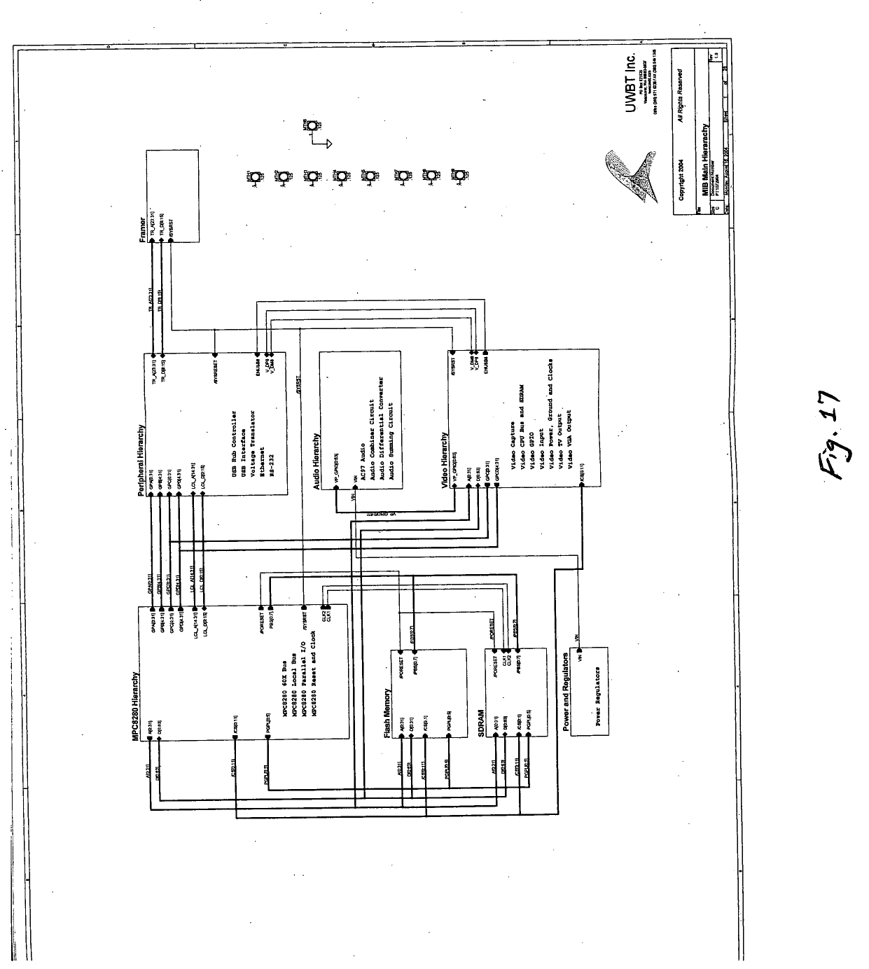

FIG. 18 is a circuit diagram and shows the AC97 Audio.

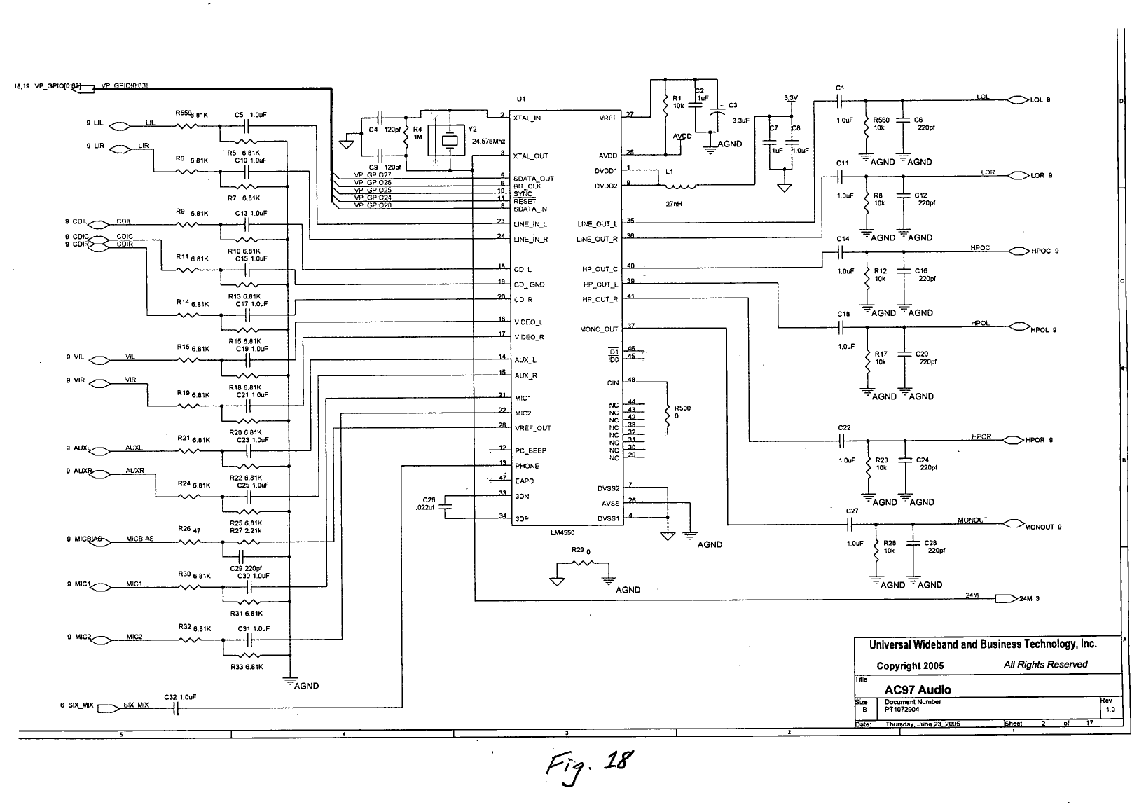

FIG. 19 is a circuit diagram and shows the Audio Combiner Circuit.

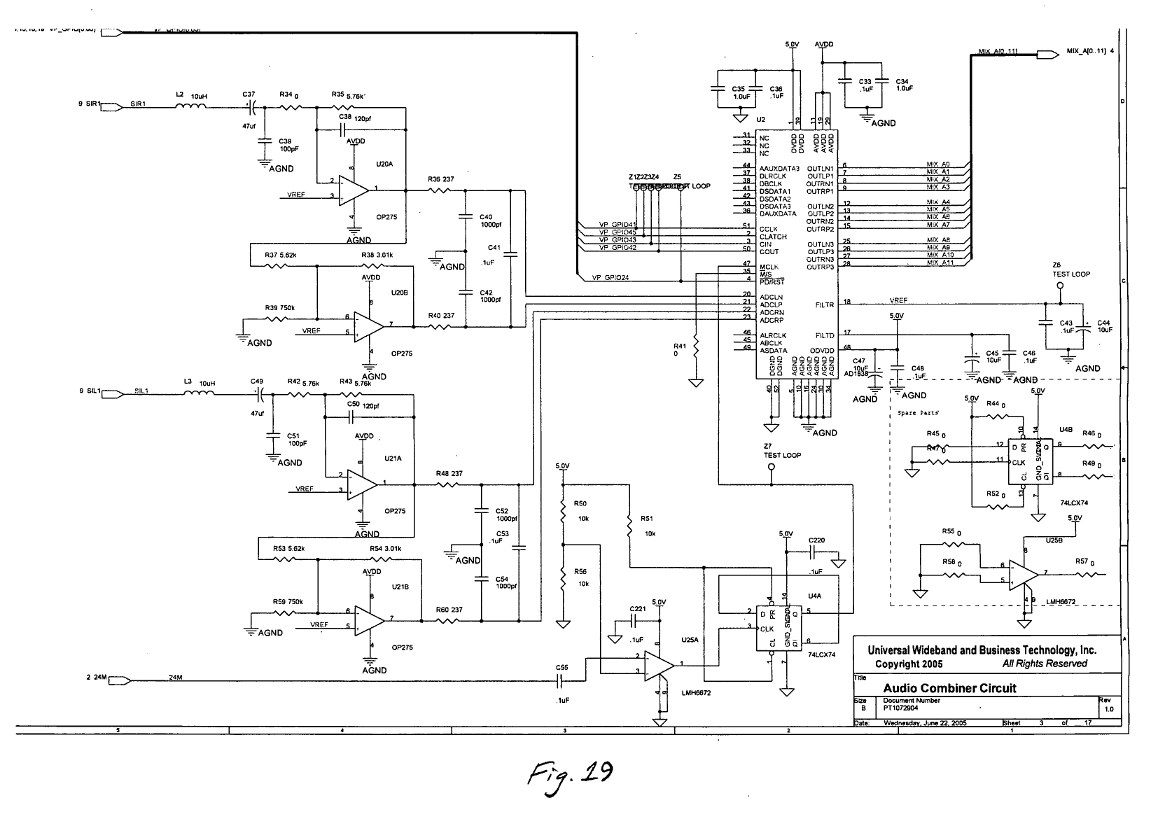

FIG. 20 is a circuit diagram and shows the Audio Differential Converter/Filter.

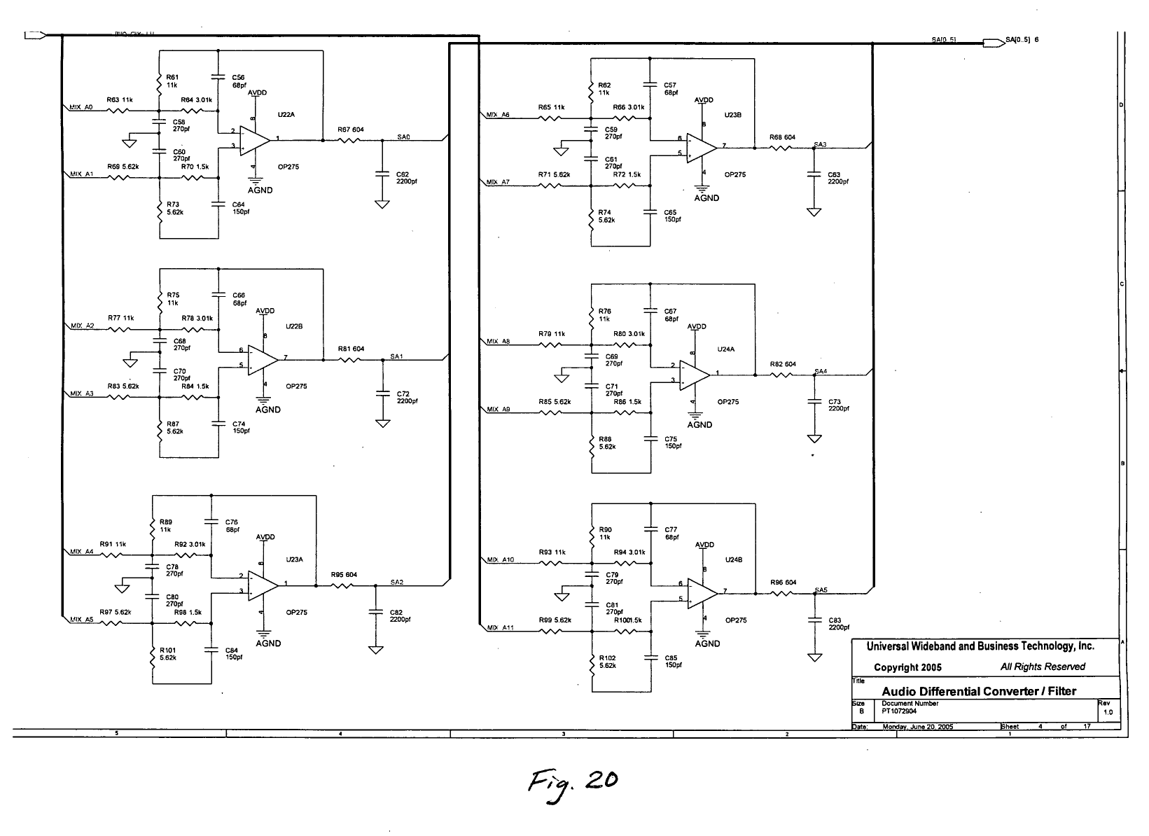

FIG. 21 is a circuit diagram and shows the Audio Hierarchy.

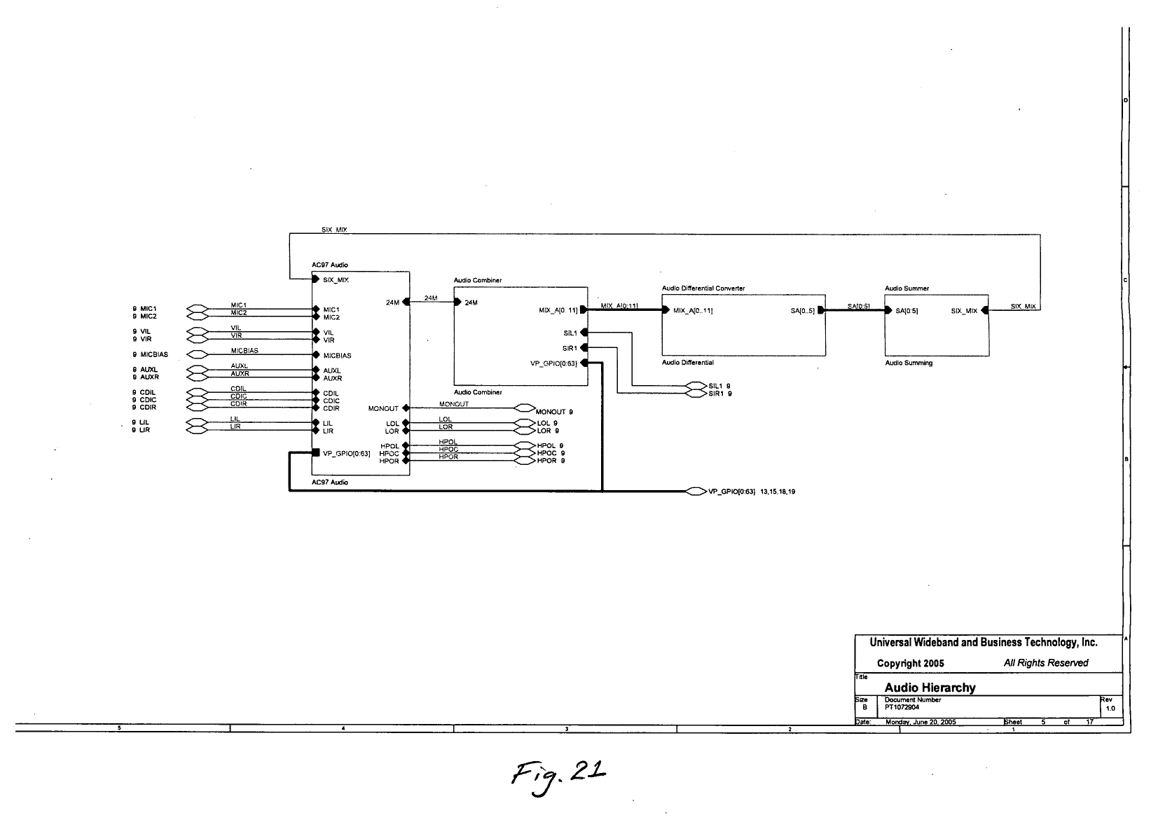

FIG. 22 is a circuit diagram and shows a Six Channel Audio Summer.

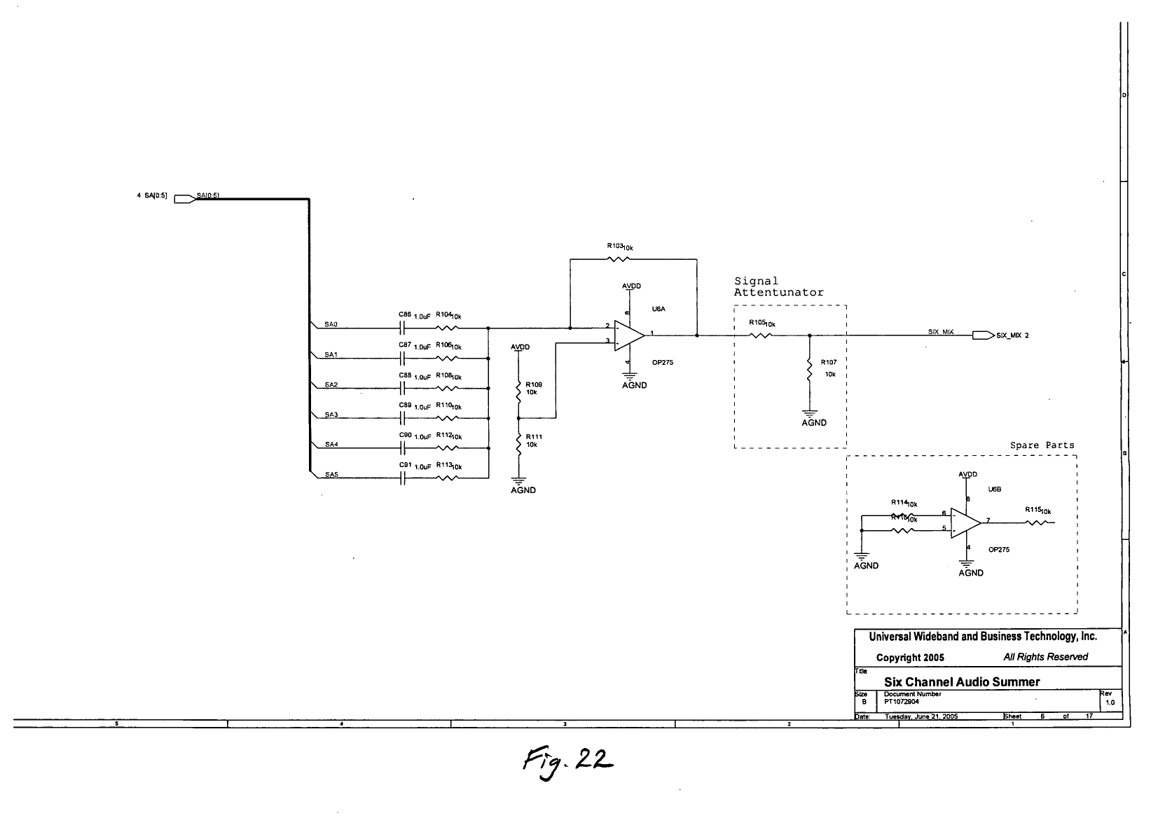

FIG. 23 is a circuit diagram and shows the Ethernet 10/100 T.

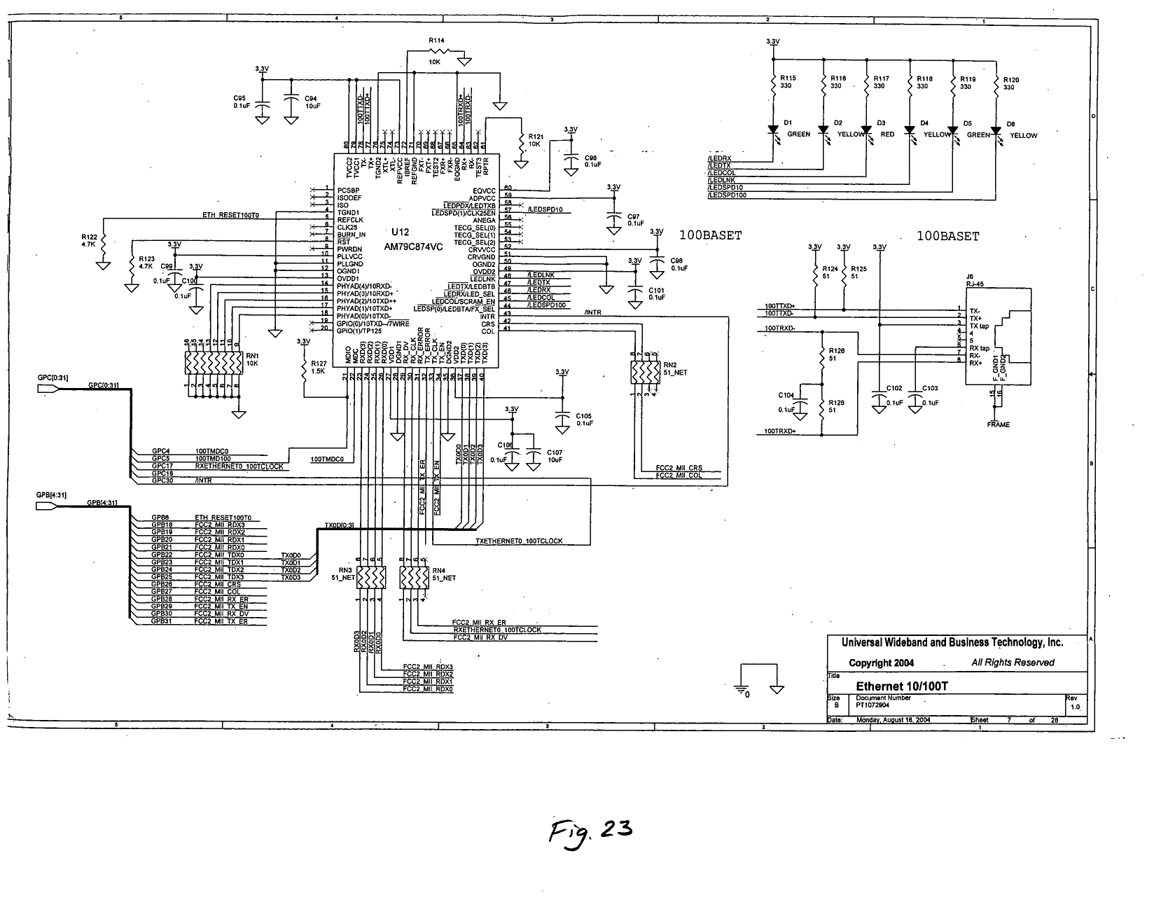

FIG. 24 is a circuit diagram and shows Flash Memory.

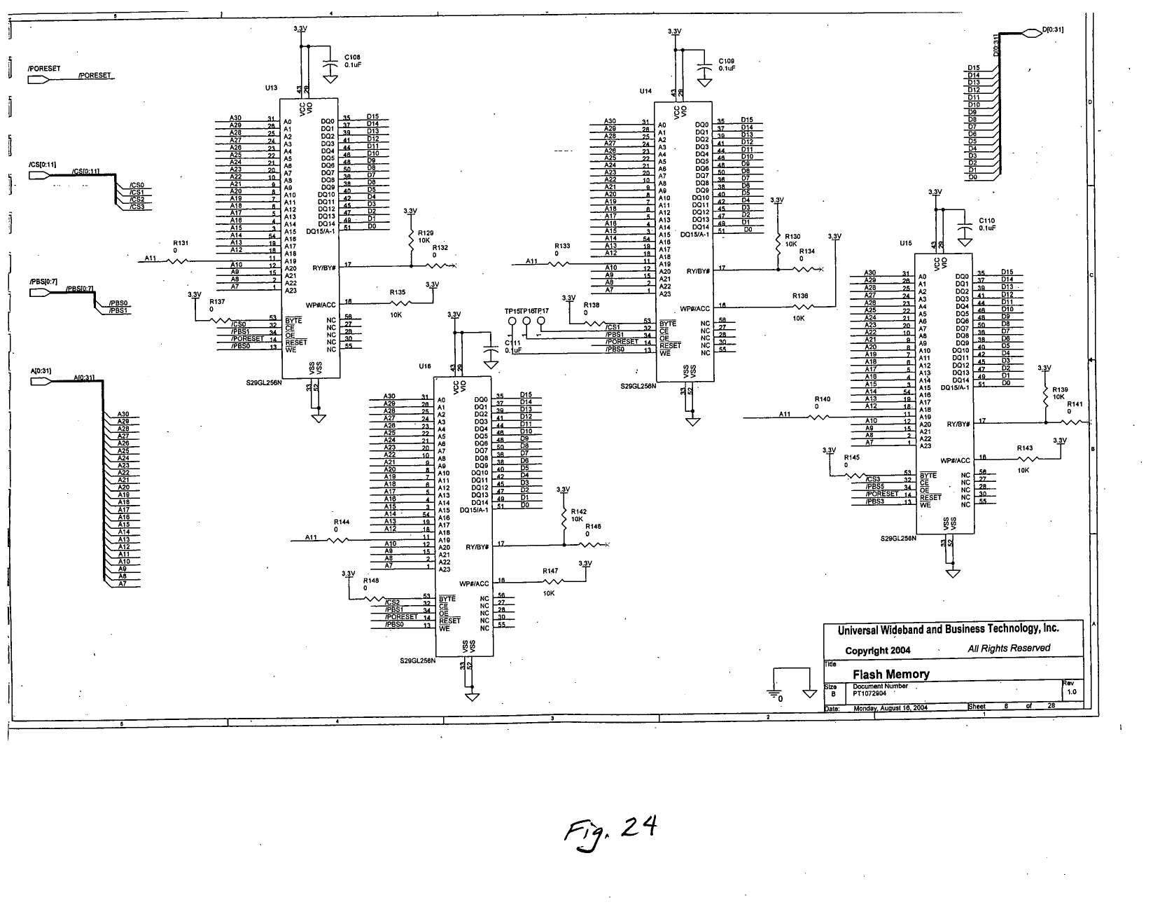

FIG. 25 is a circuit diagram and shows a Framer. Interface.

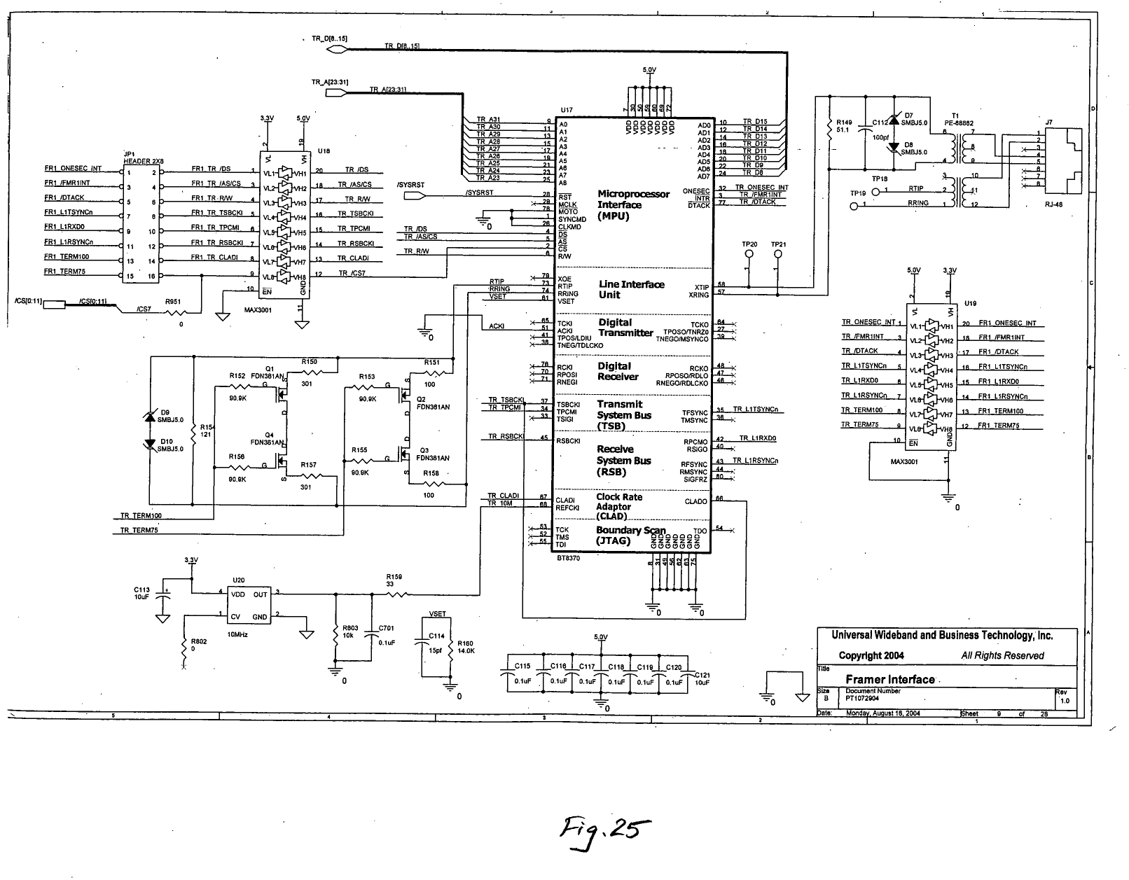

FIG. 26 is a circuit diagram and shows a MPC8280 60X Bus.

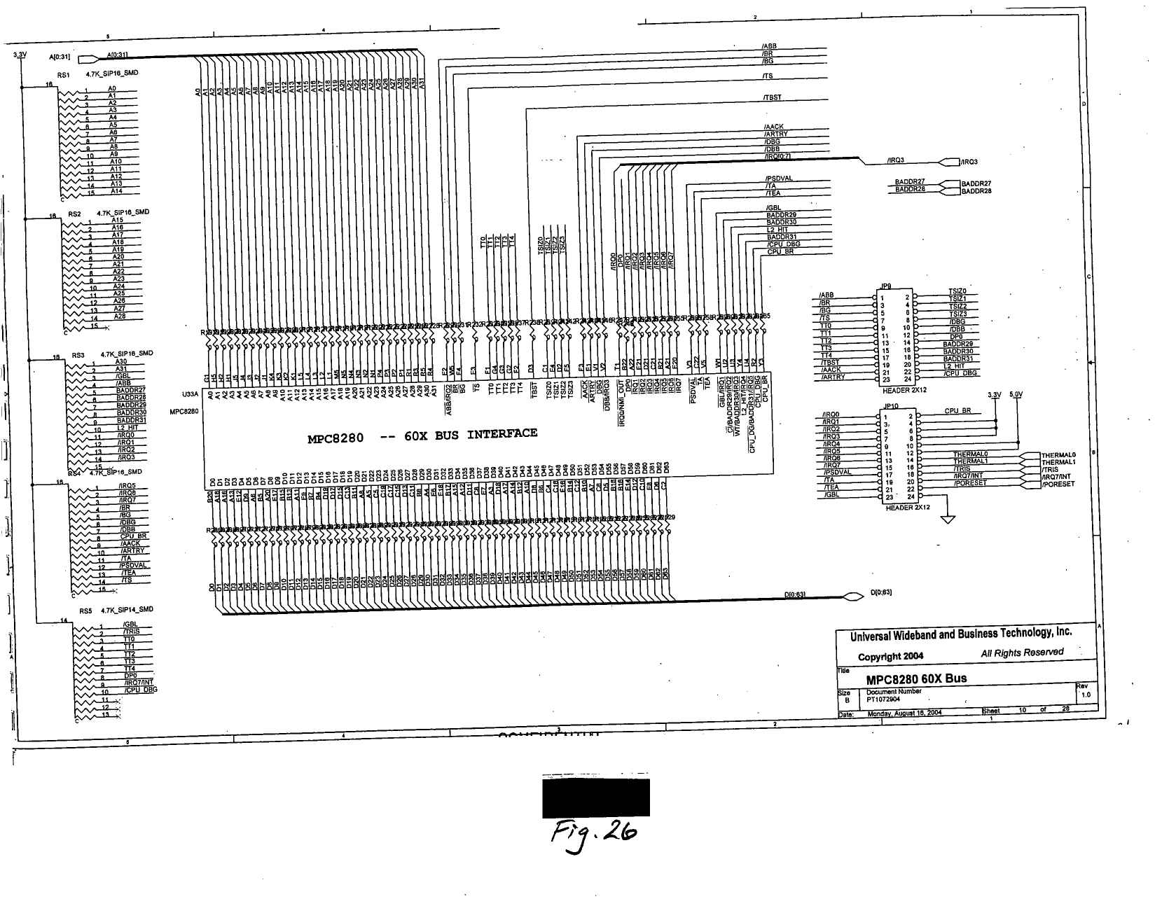

FIG. 27 is a circuit diagram and shows Microprocessor Hierarchy.

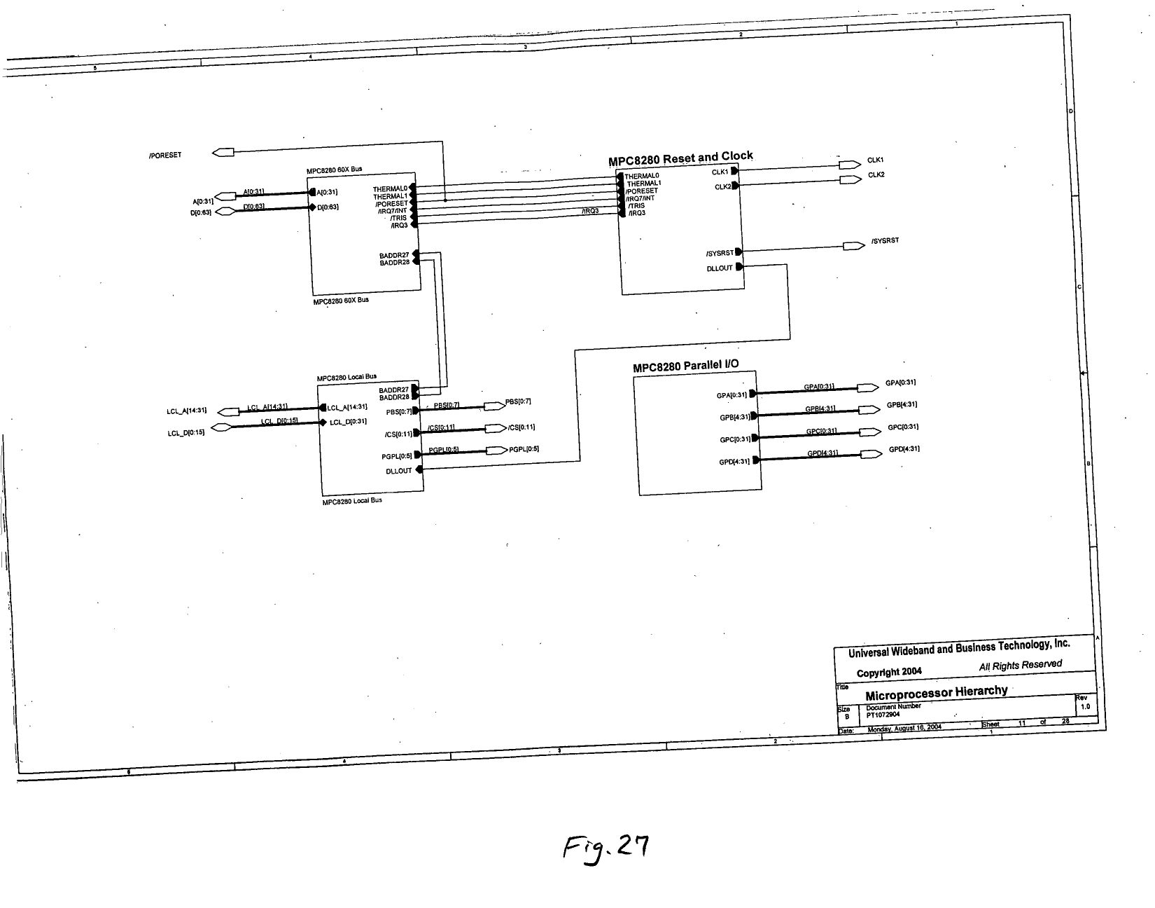

FIG. 28 is a circuit diagram and shows MPC8280 Local Bus Interface.

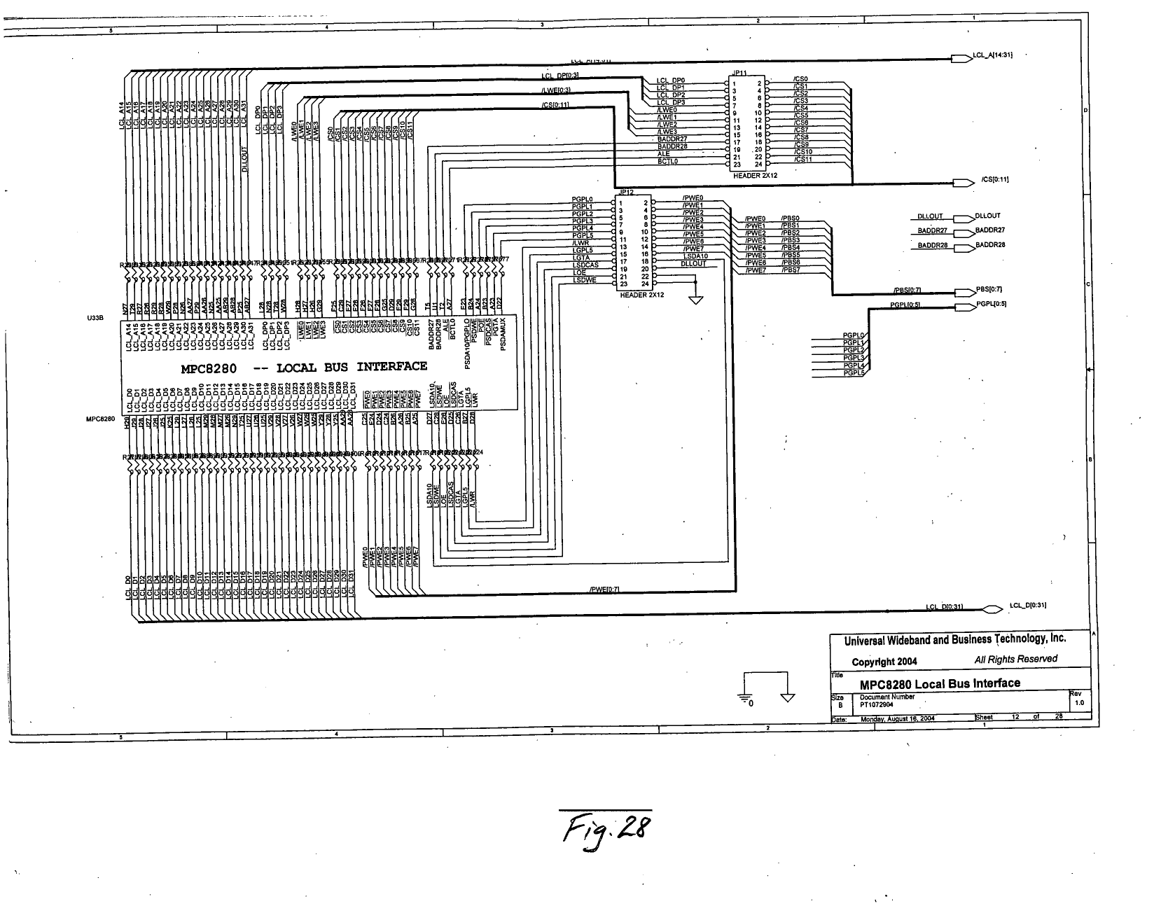

FIG. 29 is a circuit diagram and shows a MPC8280 Parallel Port Interface.

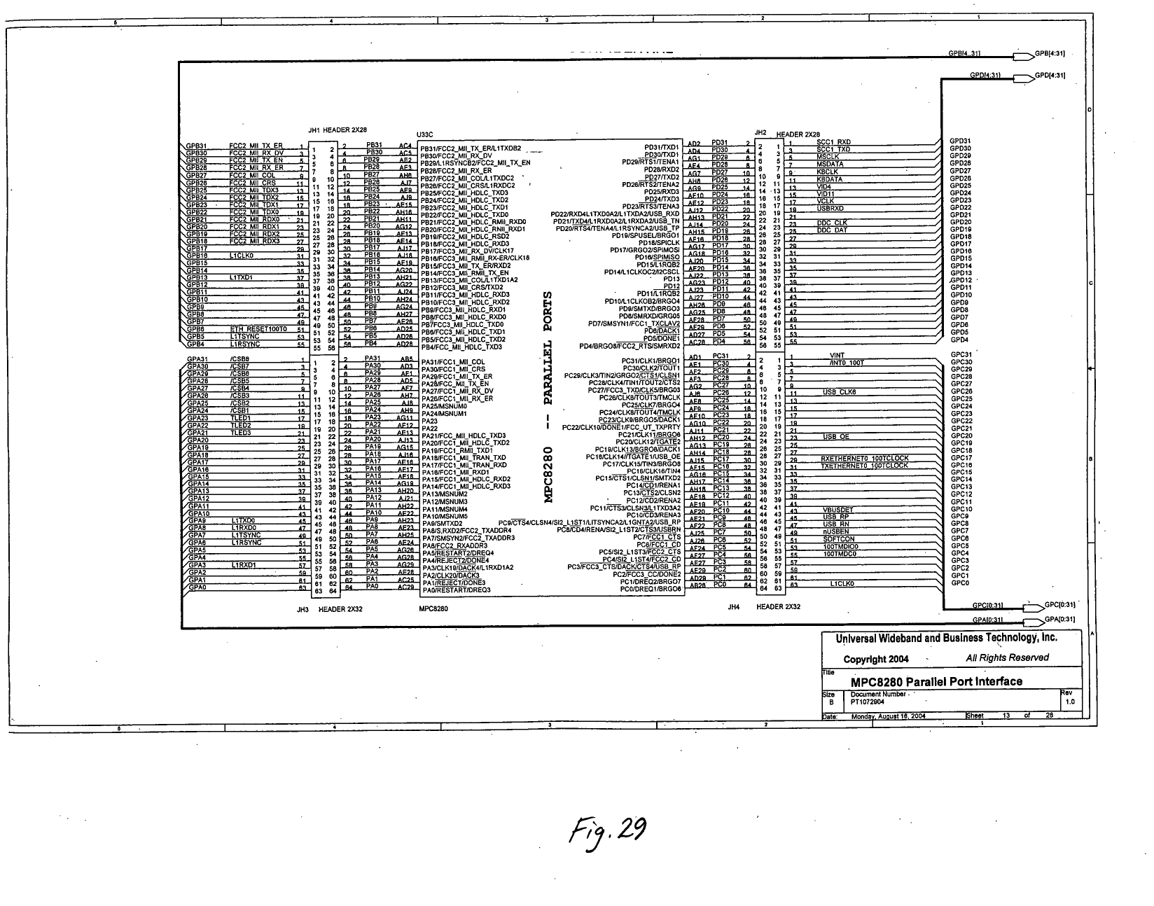

FIG. 30 is a circuit diagram and shows a MPC8280 Power, Ground, Clock and Reset.

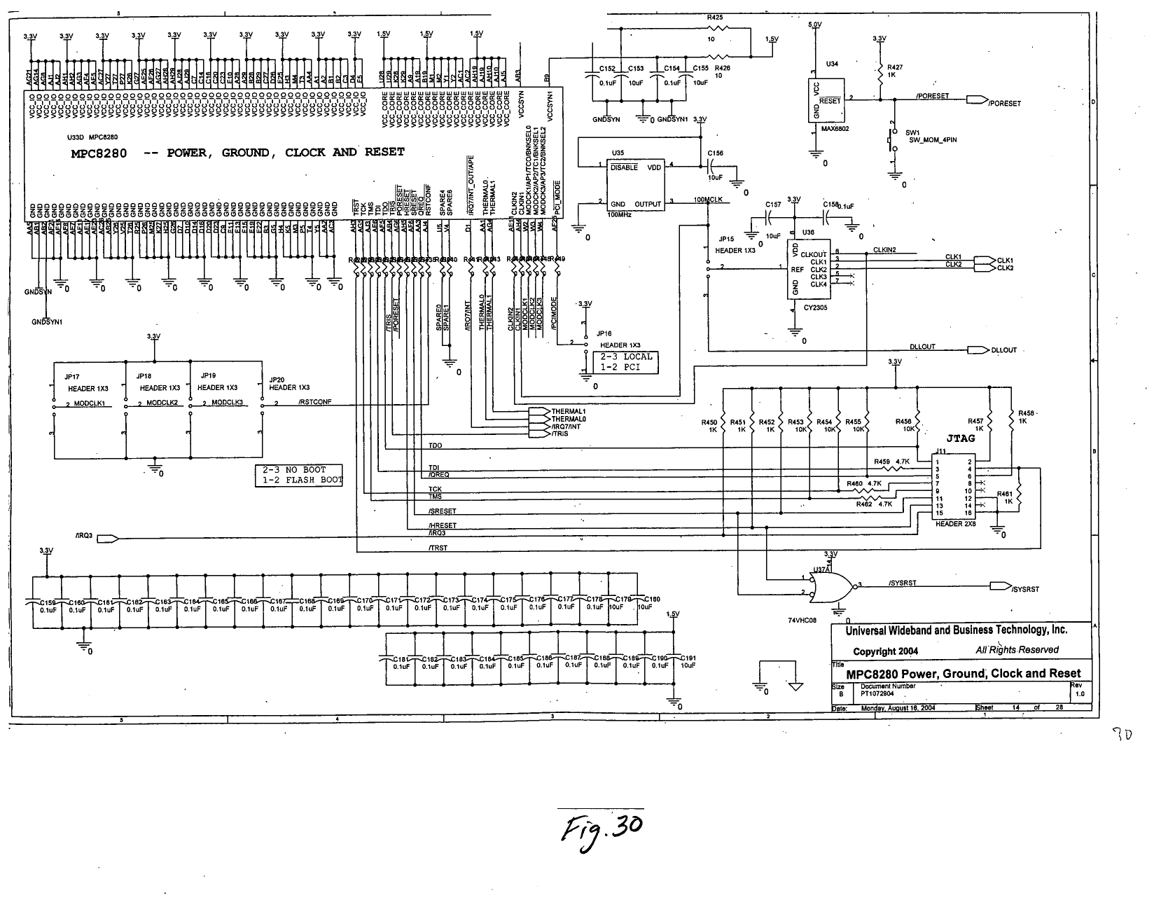

FIG. 31 is a circuit diagram and shows a Peripheral Hierarchy.

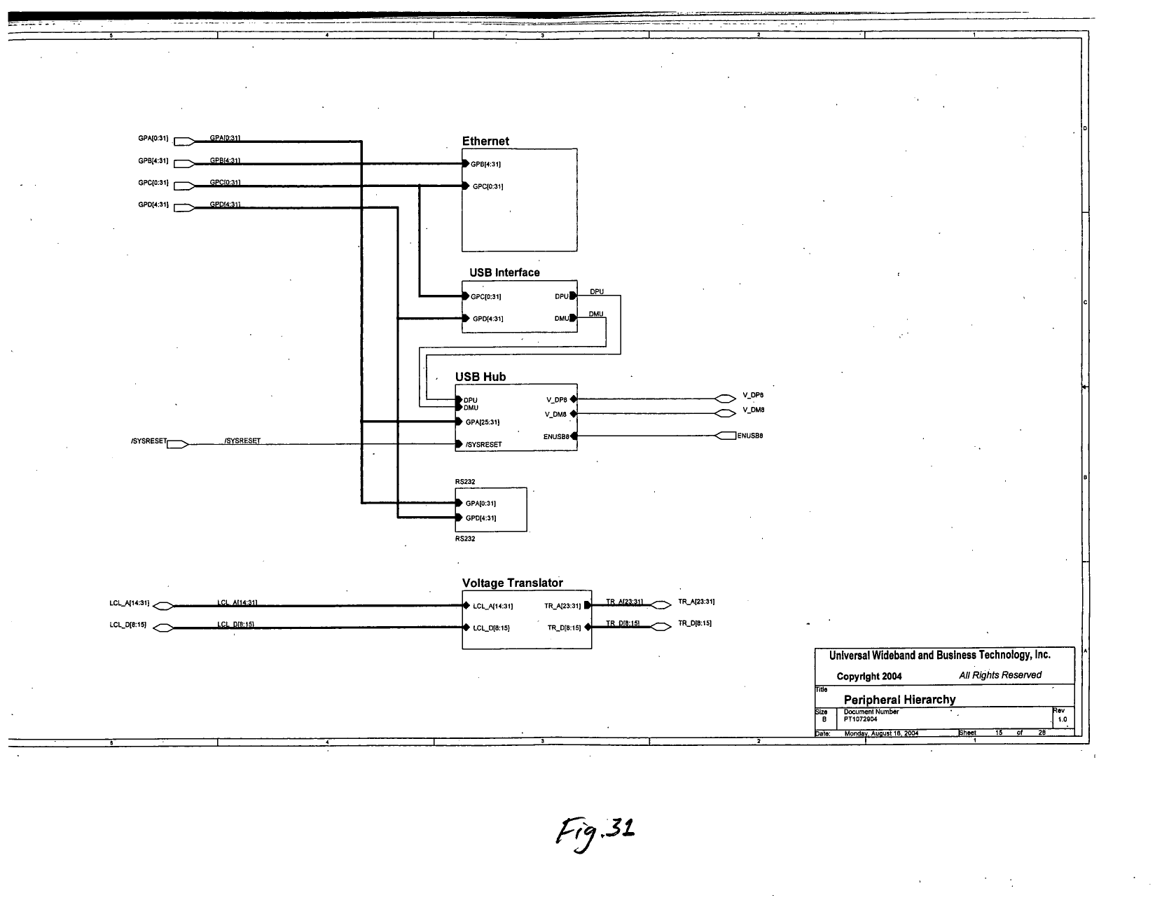

FIG. 32 is a circuit diagram and shows Power Regulators.

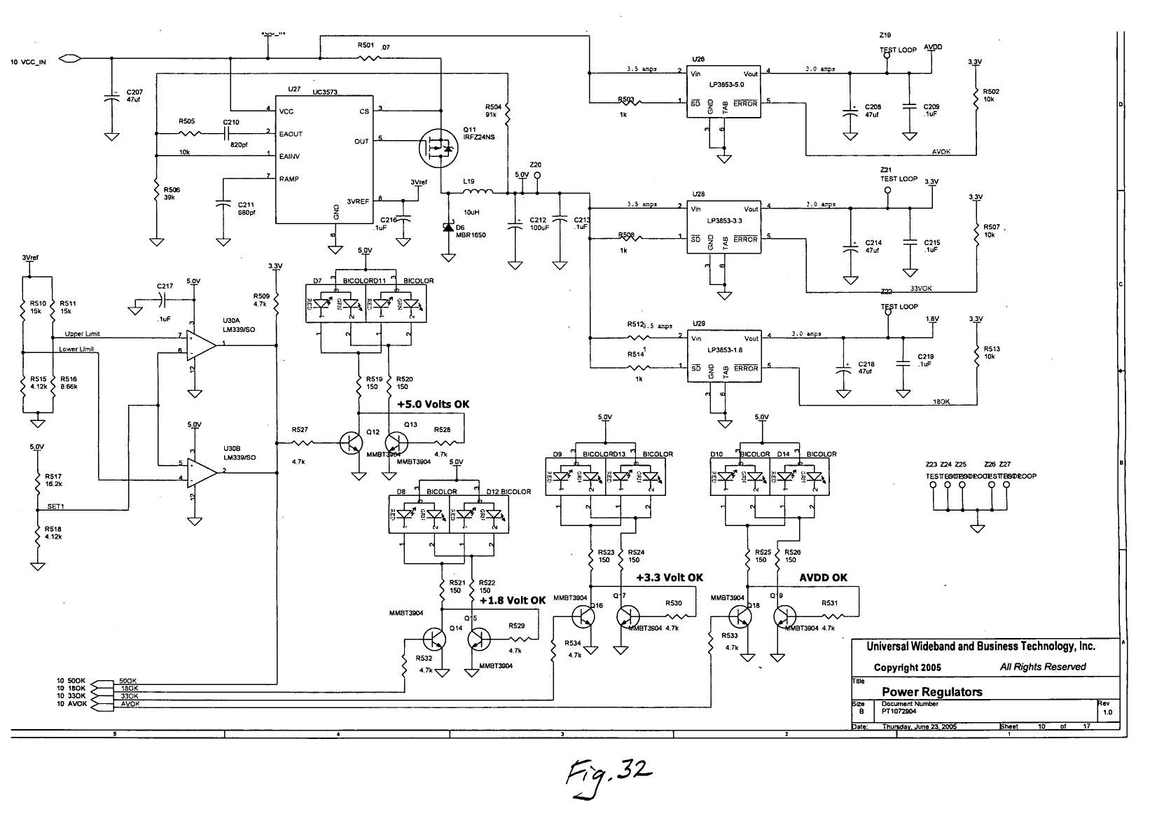

FIG. 33 is a circuit diagram and shows a MIB RS232 Interface.

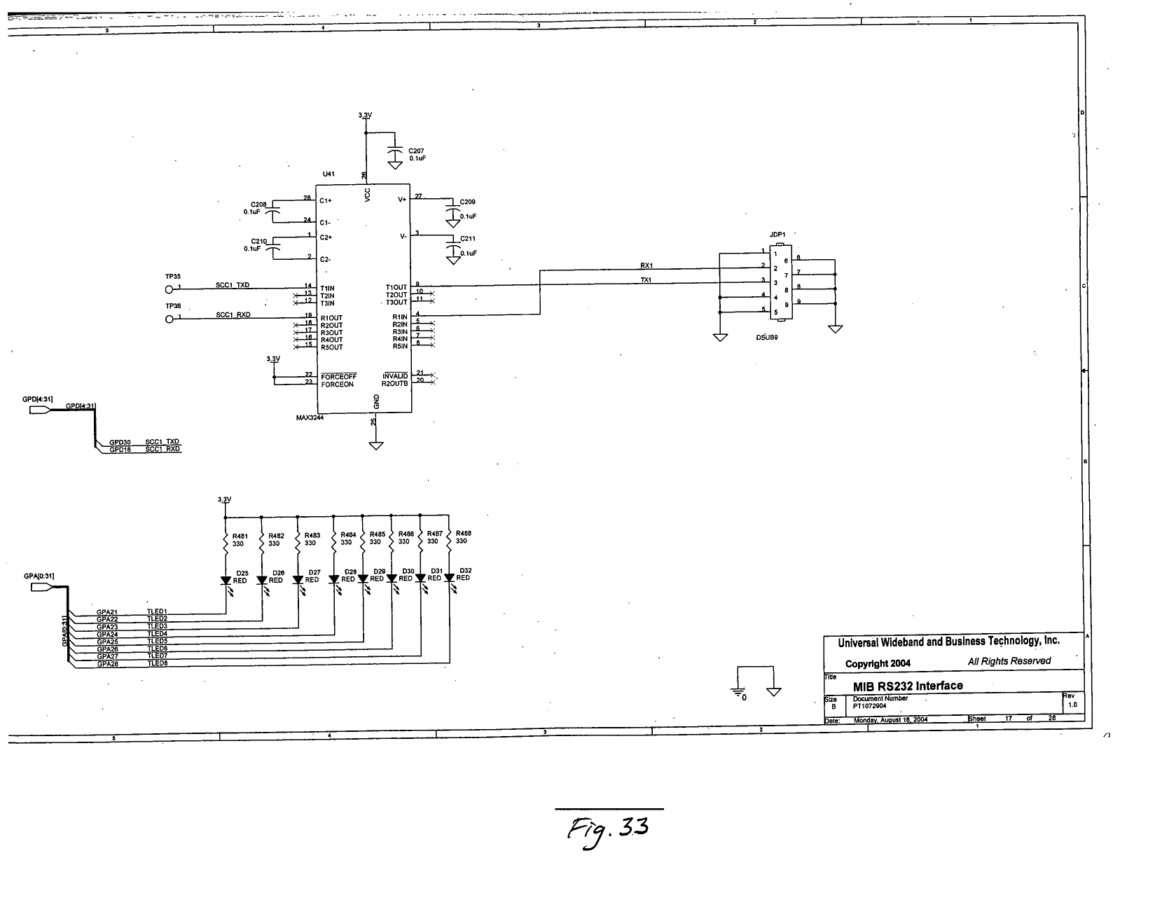

FIG. 34 is a circuit diagram and shows an SDRAM 64 M Byte.

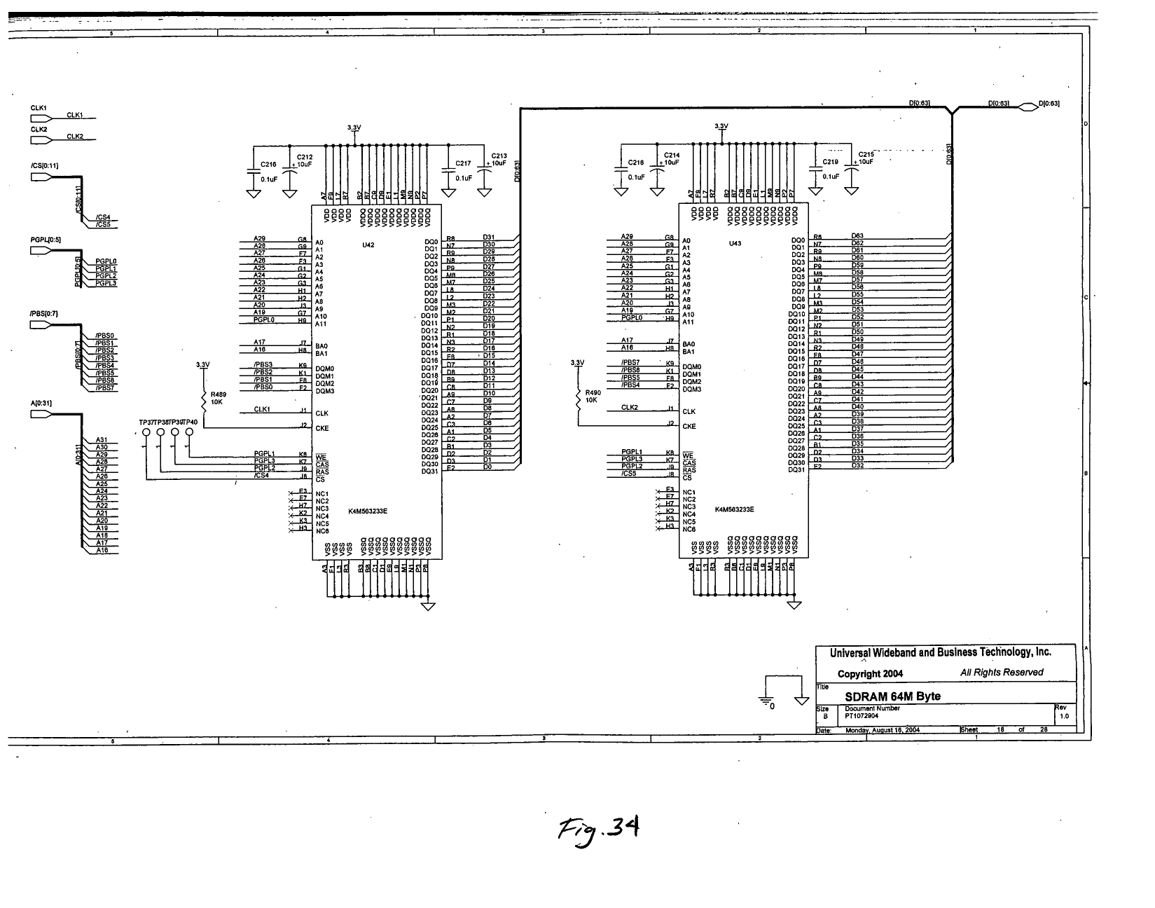

FIG. 35 is a circuit diagram and shows a USB HUB.

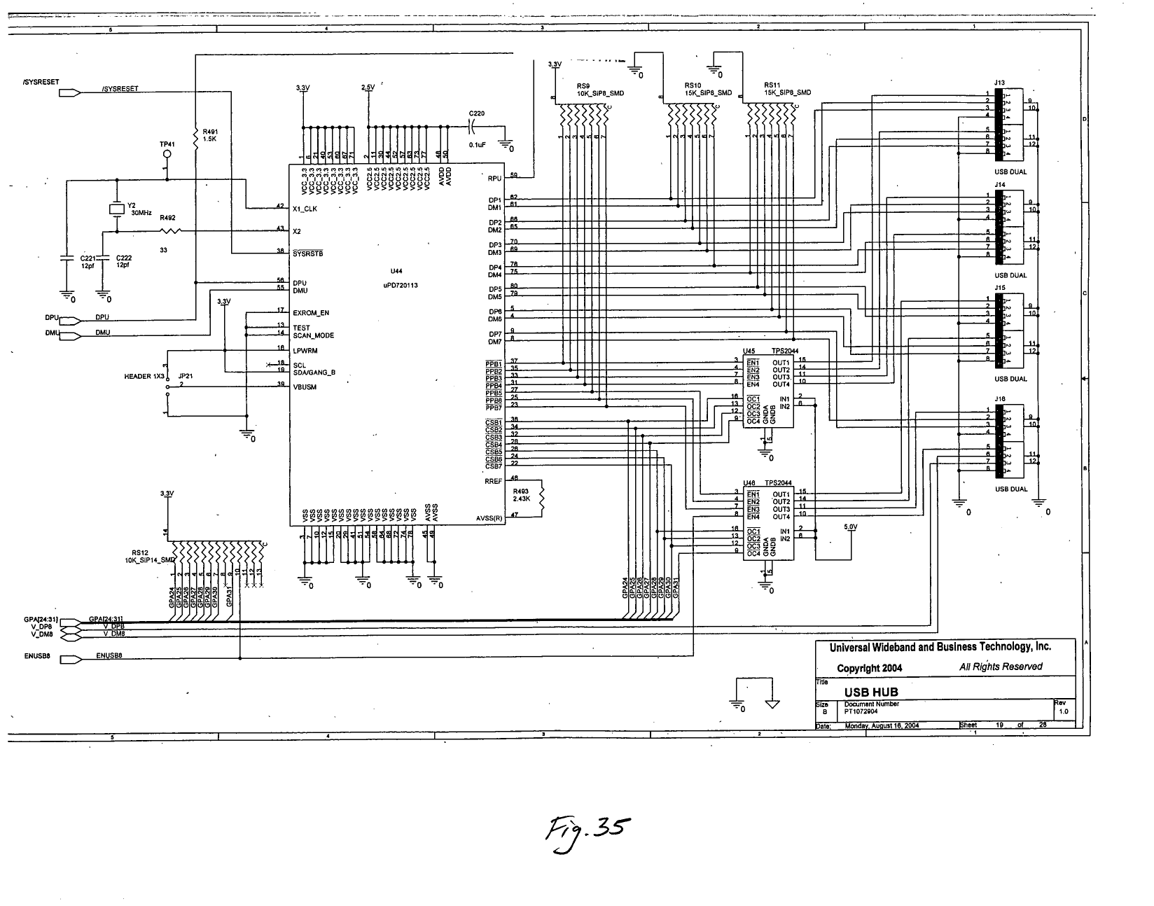

FIG. 36 is a circuit diagram and shows a USB Interface.

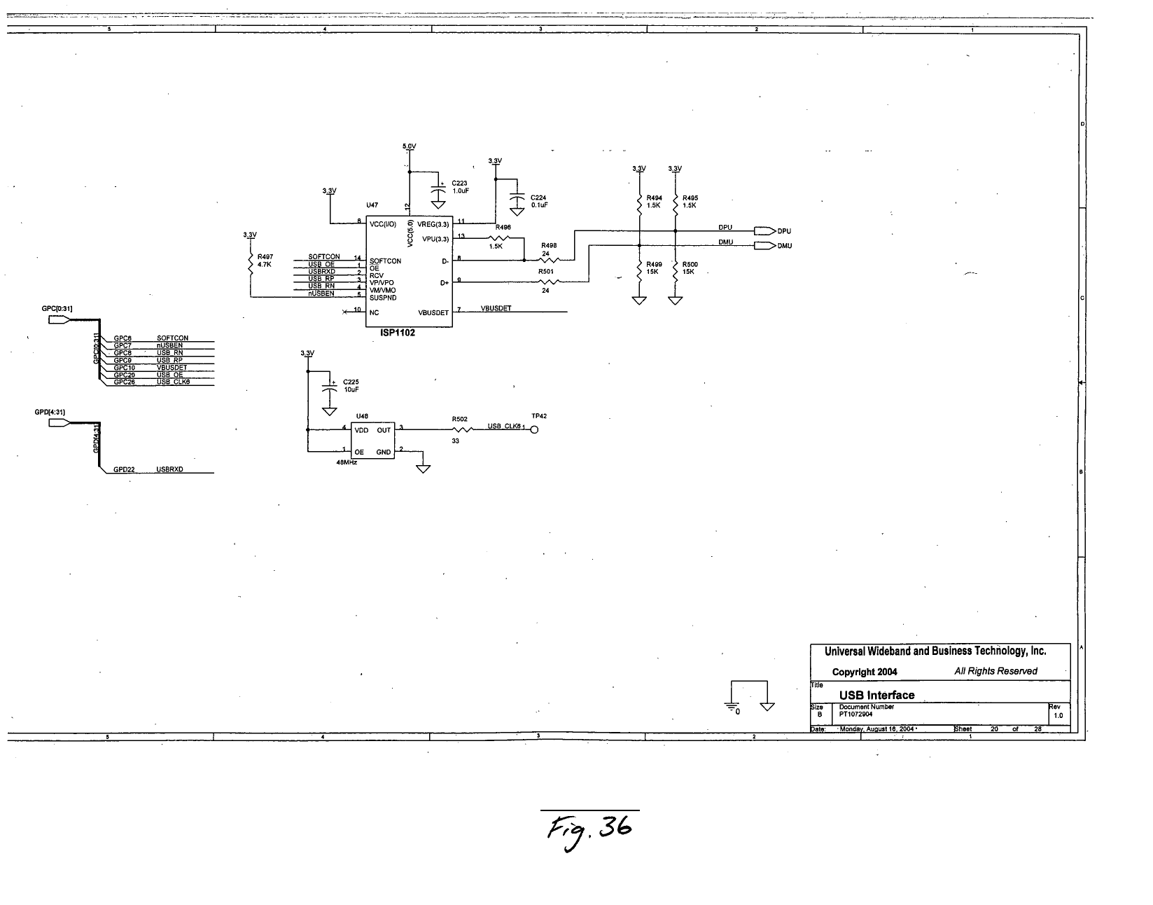

FIG. 37 is a circuit diagram and shows Video Capture.

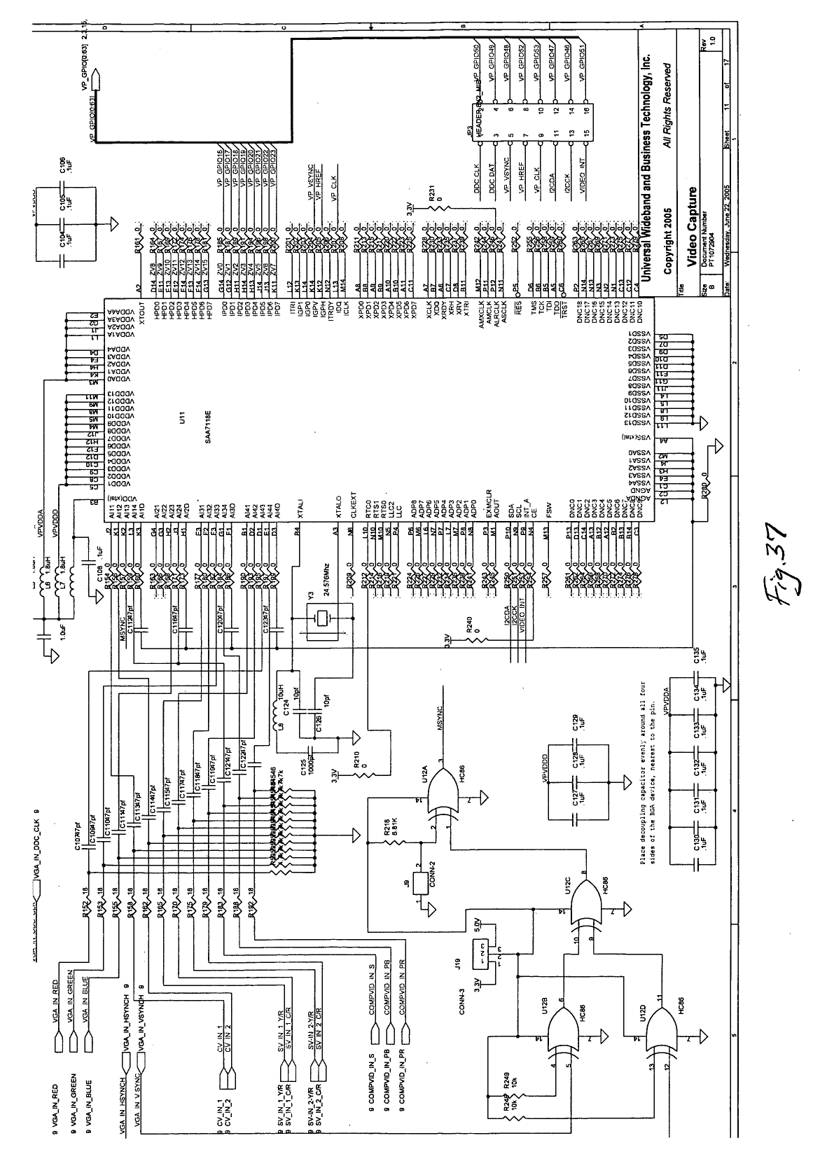

FIG. 38 is a circuit diagram and shows a Video Controller Bus Interface and Video SDRAM.

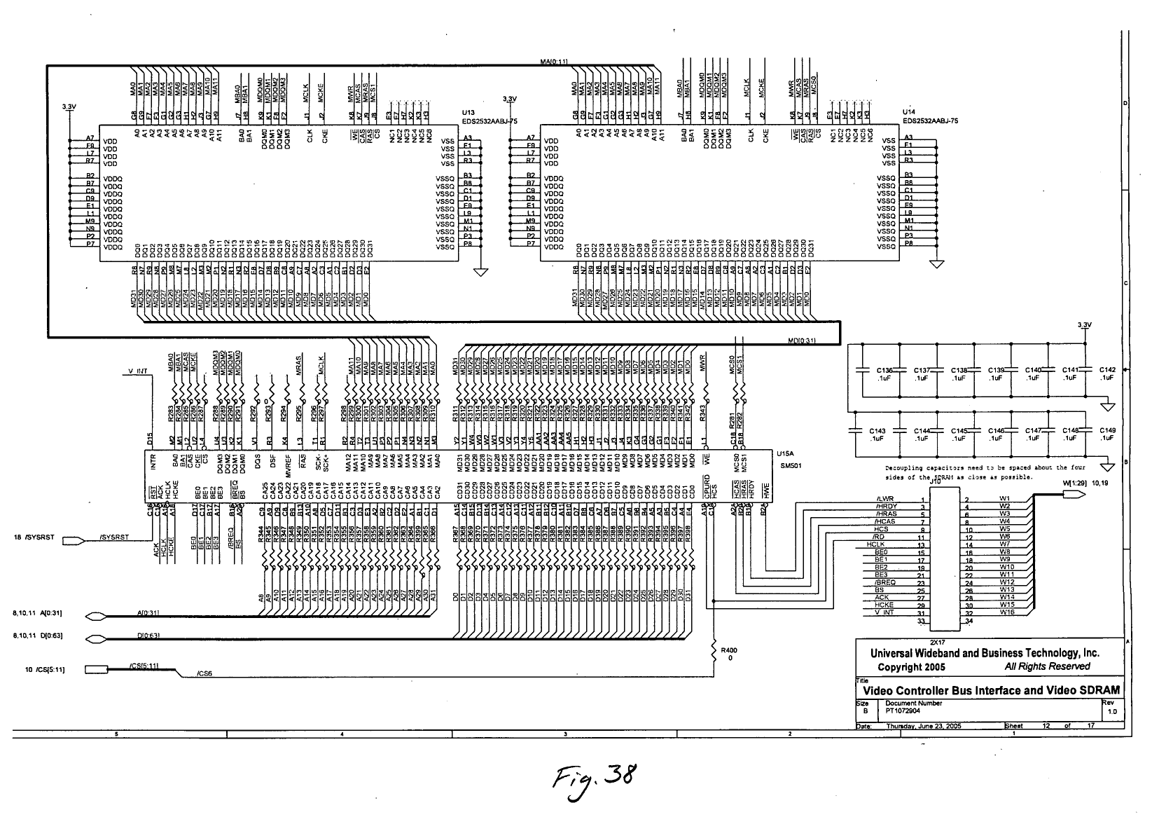

FIG. 39 is a circuit diagram and shows a Video GPIO.

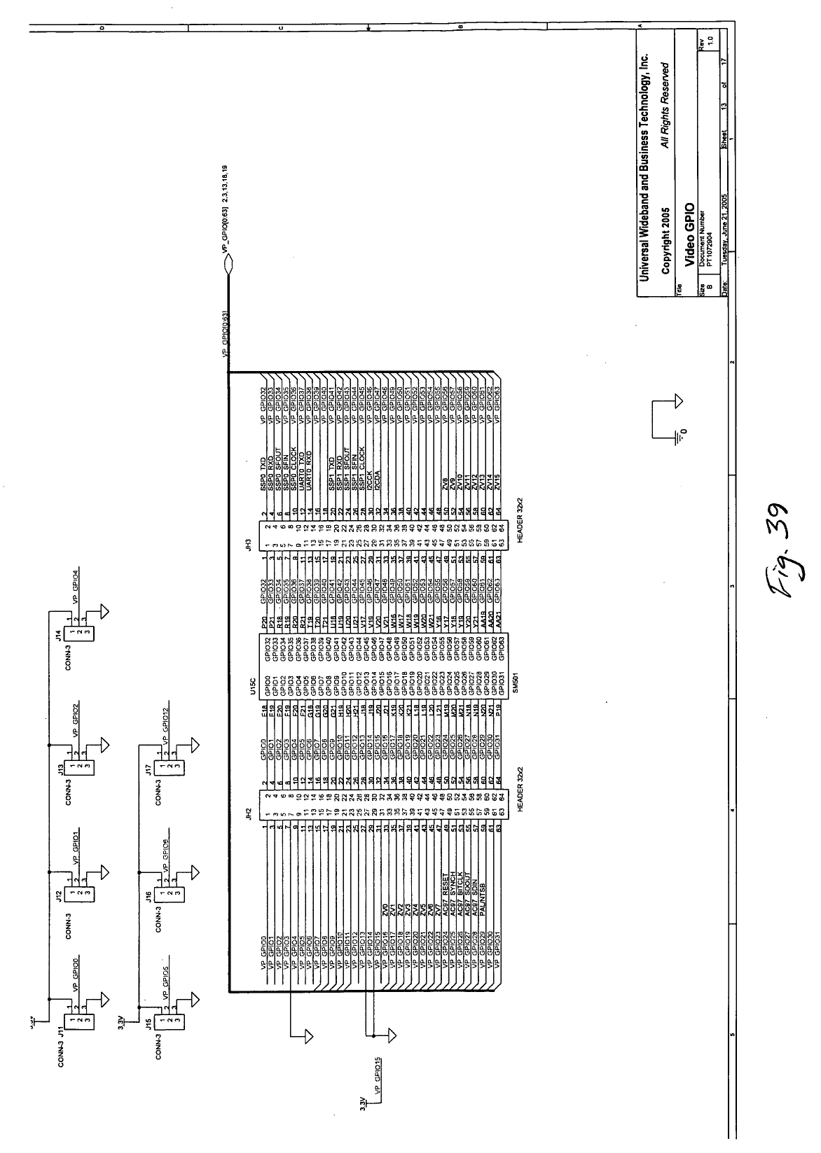

FIG. 40 is a circuit diagram and shows an MIB Video Hierarchy.

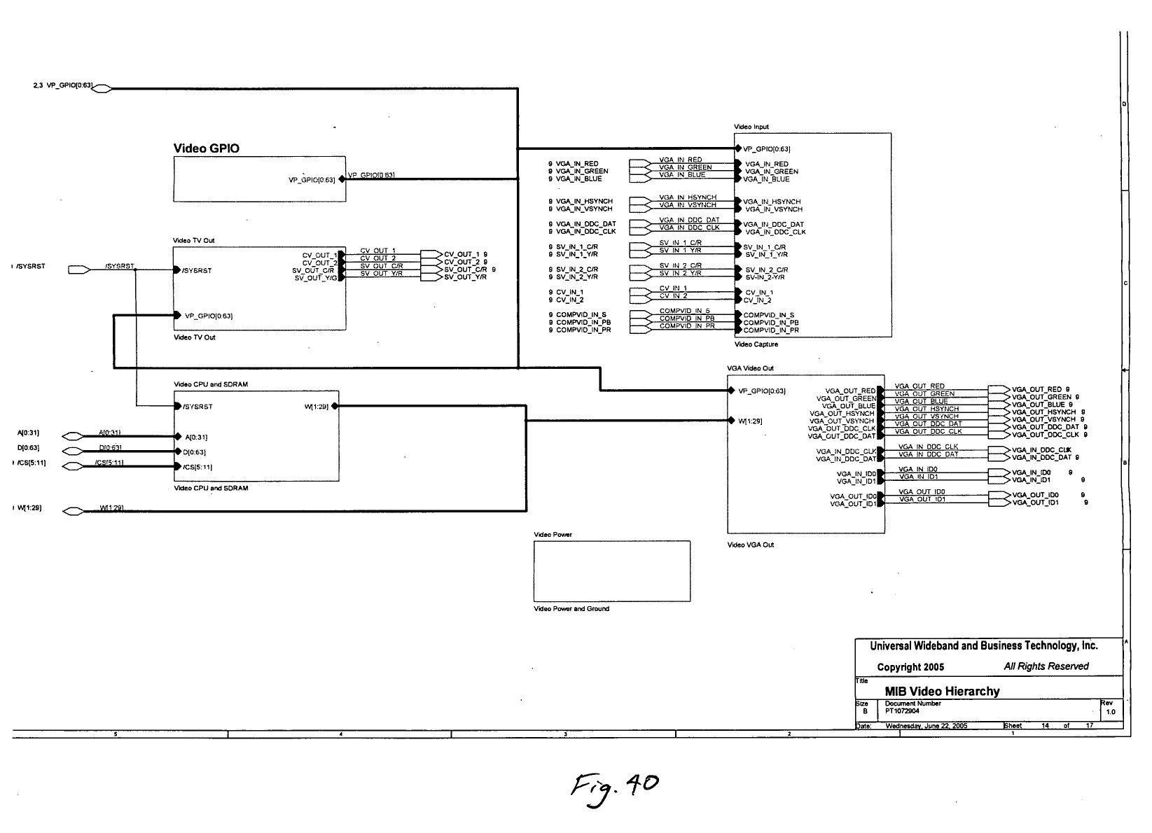

FIG. 41 is a circuit diagram and shows Video Power, Ground, and Clock.

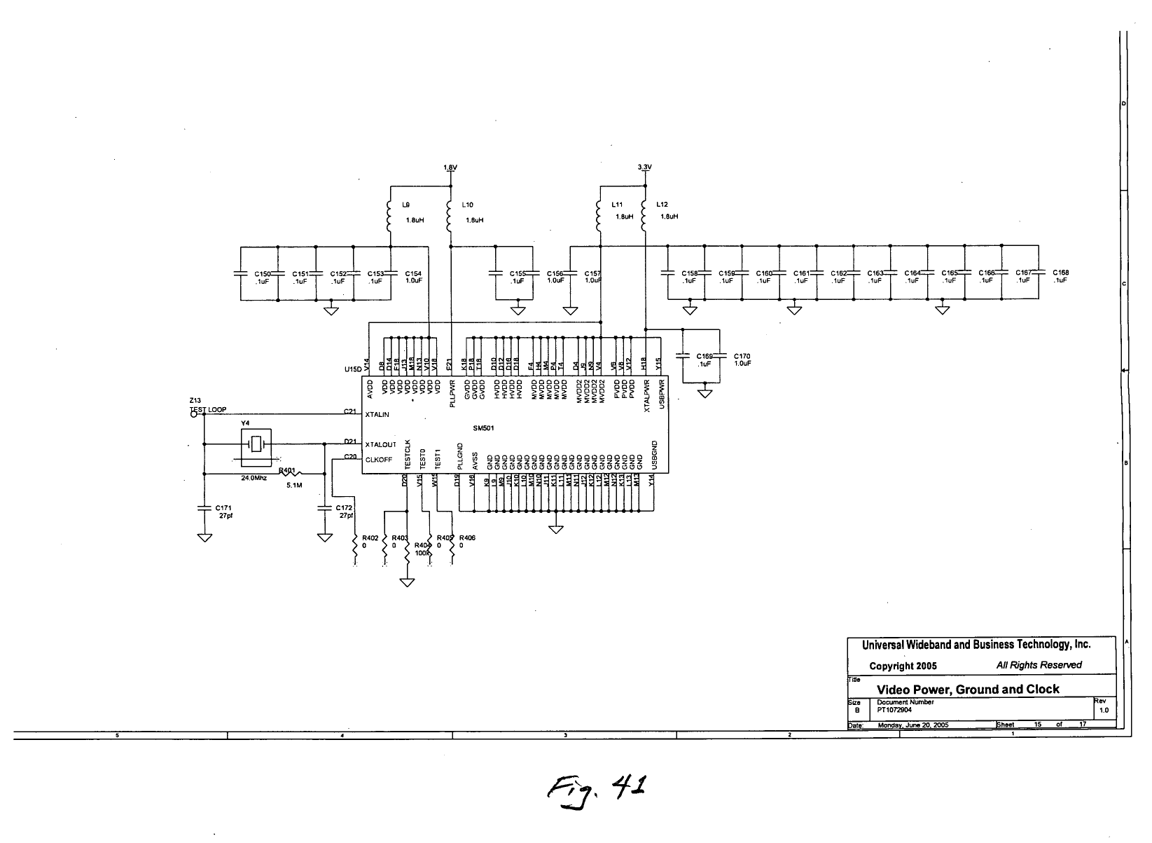

FIG. 42 is a circuit diagram and shows a TV Output.

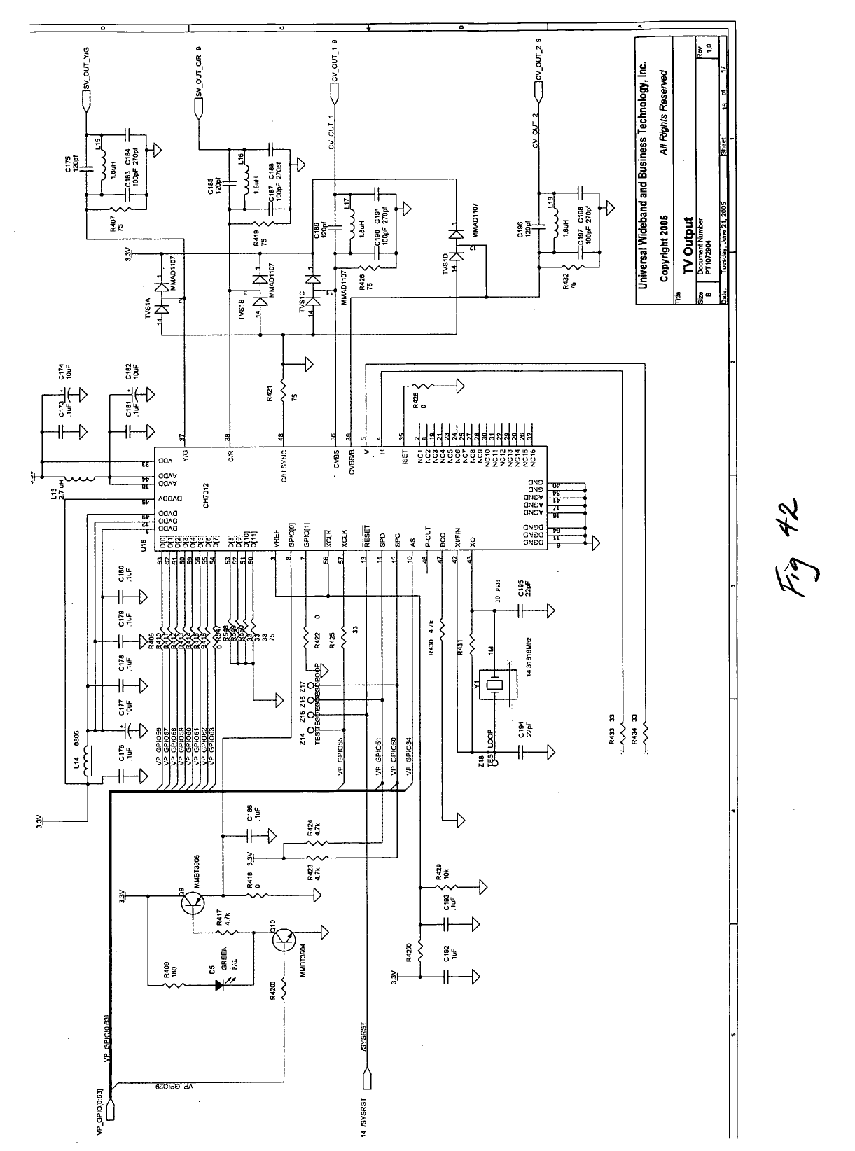

FIG. 43 is a circuit diagram and shows VGA Video Output.

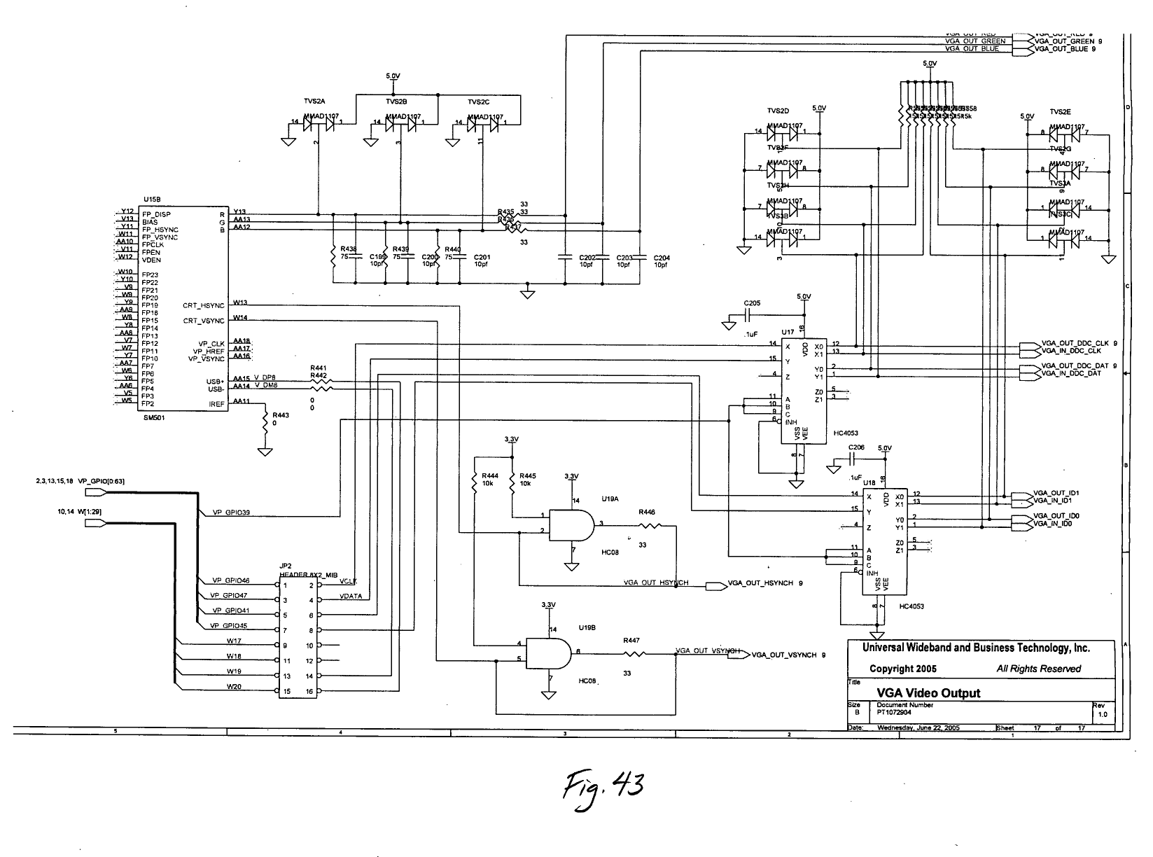

FIG. 44 is a circuit diagram and shows Address and Data Voltage Translation.

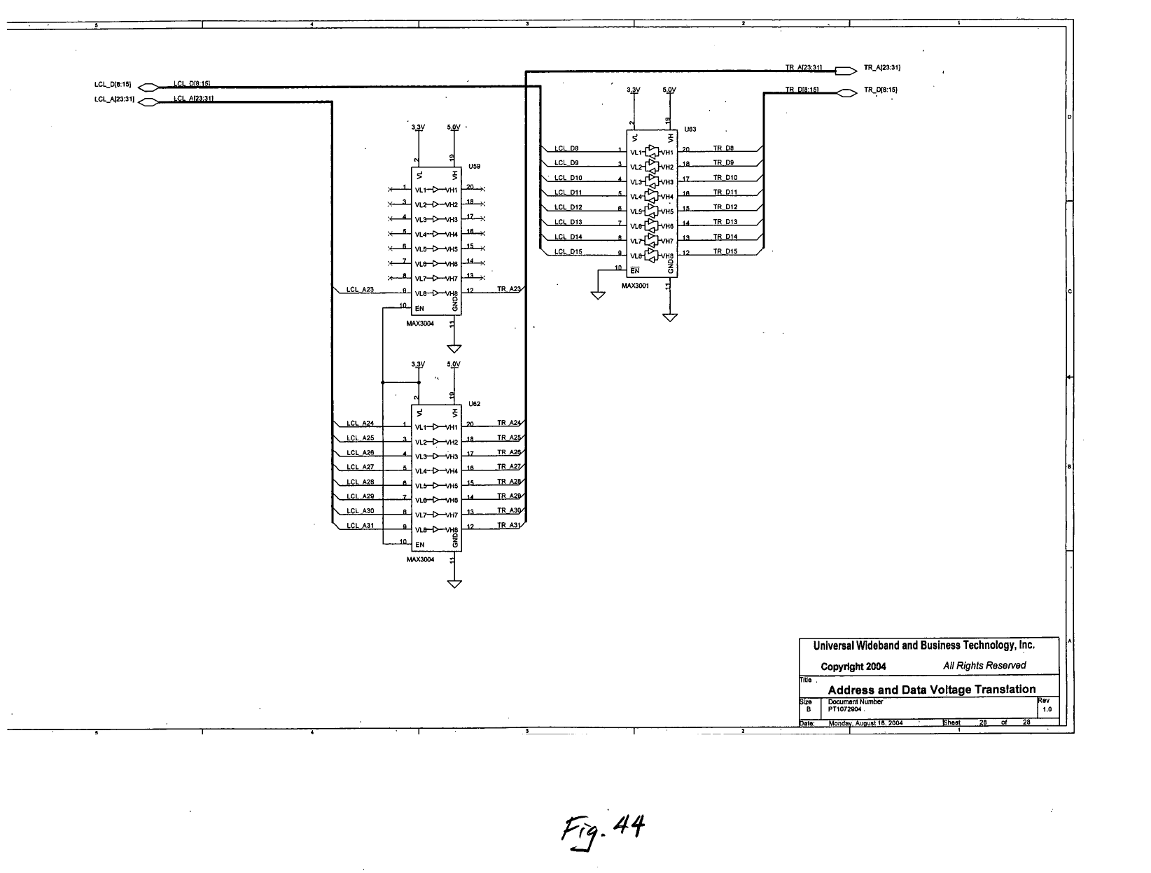

FIG. 45 is a circuit diagram and shows a Video & Audio Board.

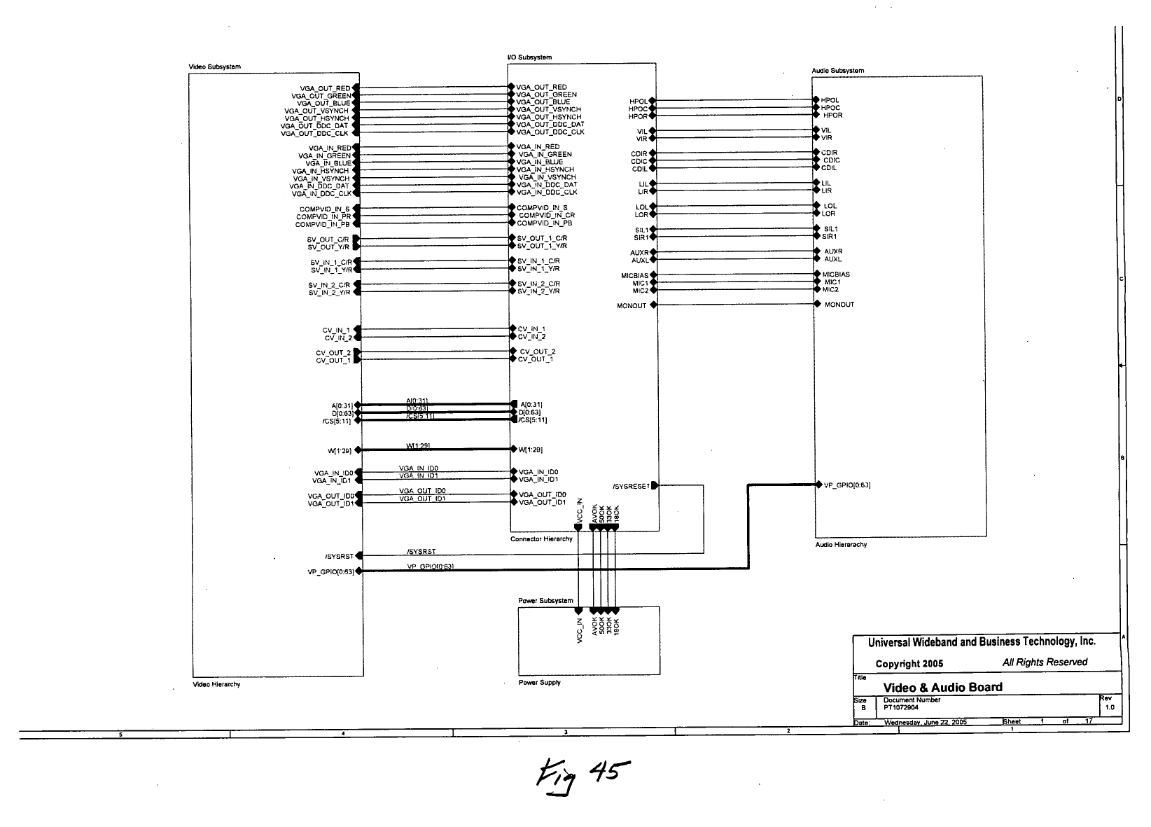

FIG. 46 is a circuit diagram and shows Connector Hierarchy.

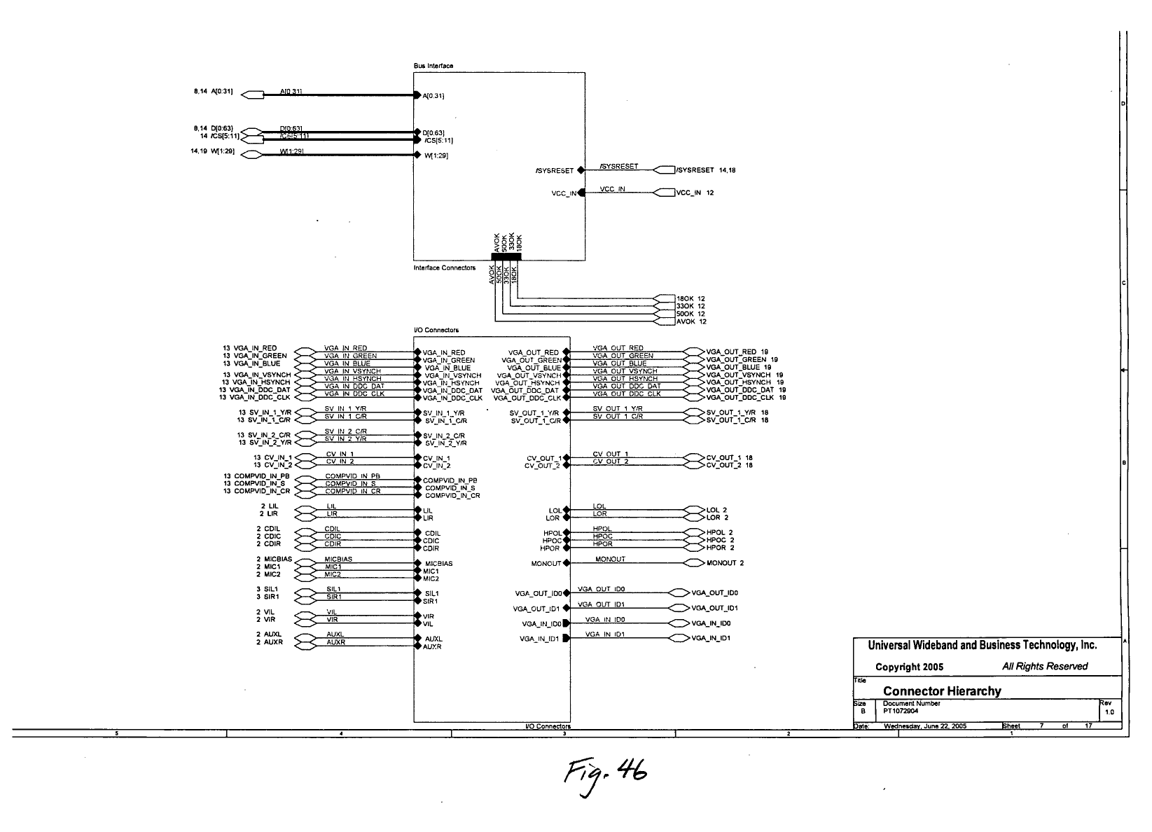

FIG. 47 is a circuit diagram and shows Panel Connectors.

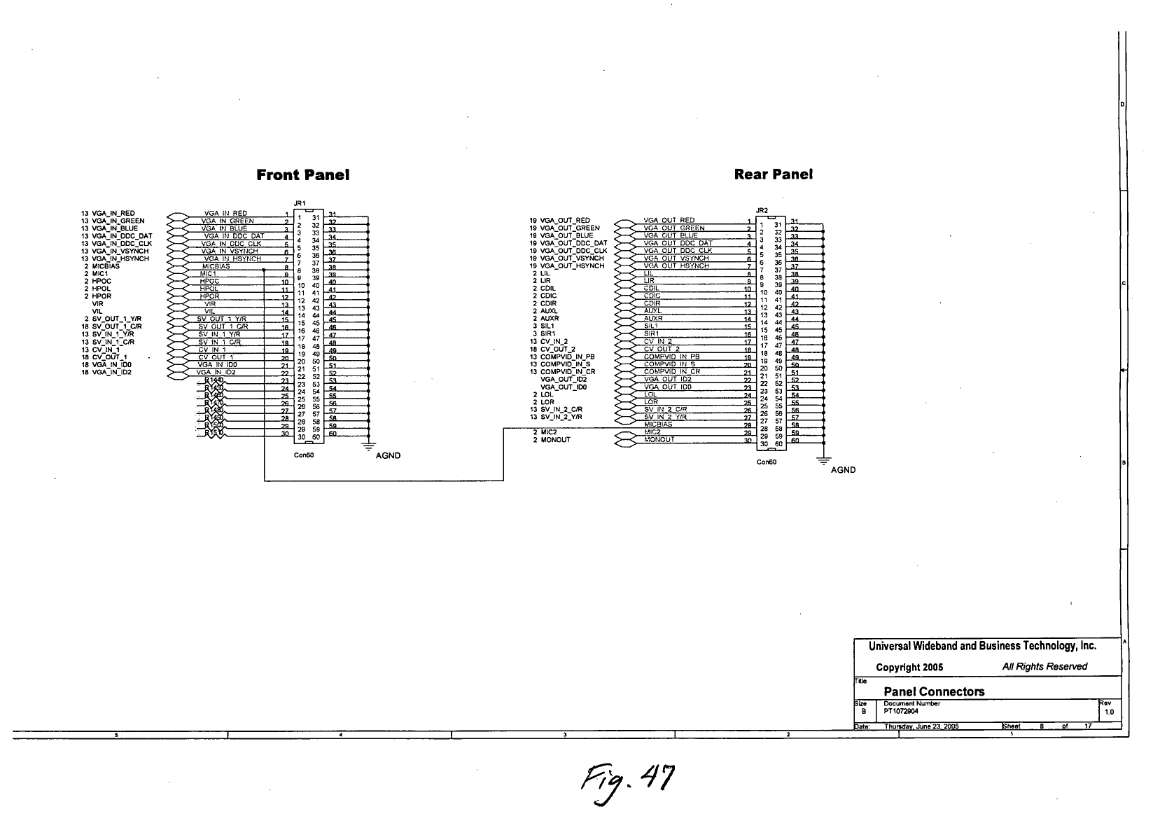

FIG. 48 is a circuit diagram and shows Expansion Port Connectors.

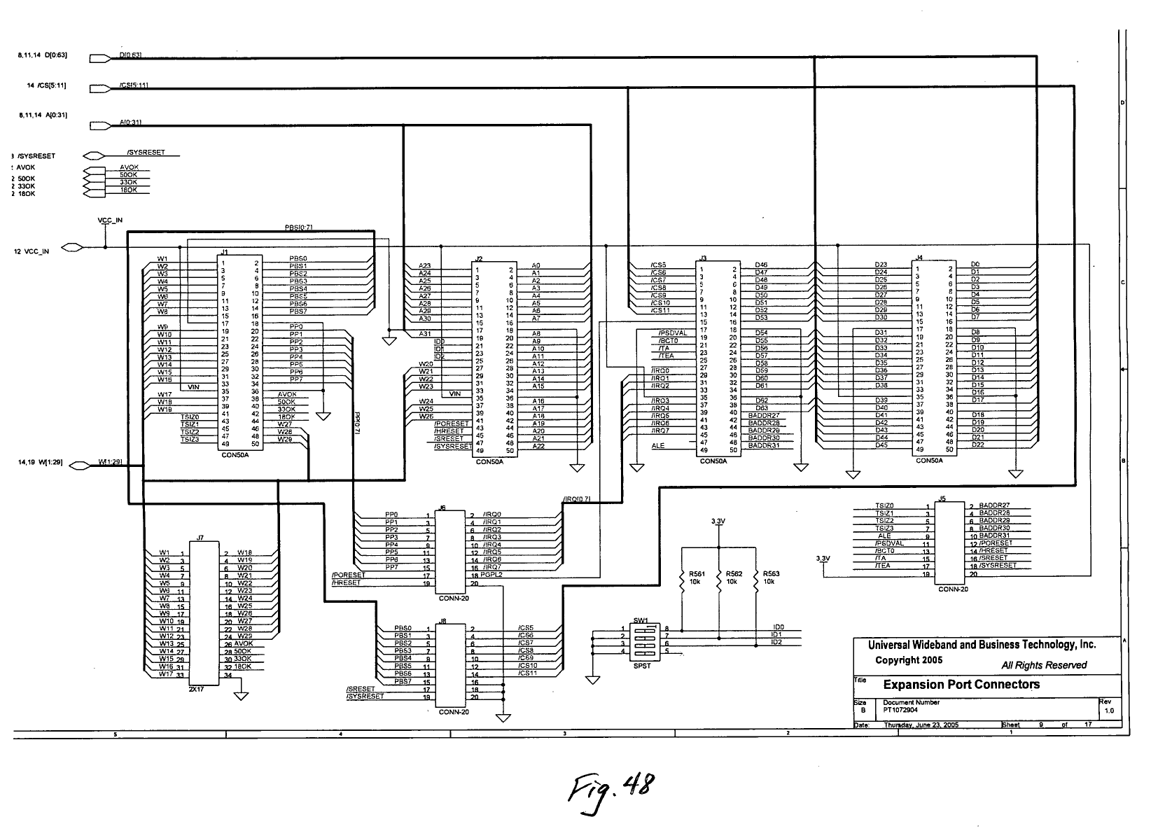

### DETAILED DESCRIPTION OF THE PREFERRED EMBODIMENTS

The term MPEG refers to the data transmission standards developed by the International Standards Organisation working group “Motion Pictures Expert Group” and in particular but not exclusively the MPEG-2 standard developed for digital television applications and set out in the documents ISO 13818-1, ISO 13818-2, ISO 13818-3 and ISO 13818-4. In the context of the present patent application, the term includes all variants, modifications or developments of MPEG formats applicable to the field of digital data transmission.

Preferably, the apparatus comprises control signal management means for managing signals for controlling one demultiplexing device to demultiplex at least first and second data streams over a common time period.

Also preferably, the apparatus comprises control signal management means for managing signals for controlling one or more remultiplexing devices to remultiplex at least first and second data streams for recording over a common time period.

In a further aspect of the invention, there is provided apparatus for processing data, comprising means for operating a demultiplexer to demultiplex a plurality of services simultaneously. This aspect may benefit from increased flexibility. The demultiplexer operating means may, for example, be adapted to effect the demultiplexing of at least three, five, ten or twenty services simultaneously.

In a particularly preferred embodiment, the demultiplexer operating means comprises means for allocating a respective logical demultiplexer as described above to each service to be demultiplexed.

In a further aspect of the invention, there is provided apparatus for controlling a demultiplexing process in a receiver/decoder, comprising control signal management means for managing signals for controlling one demultiplexing device to demultiplex at least first and second data streams over a common time period.

The control signal management means may be adapted to maintain a first family of devices for use together in controlling the demultiplexing device to demultiplex said first data stream, and to maintain a second family of devices for use together in controlling the demultiplexing device to demultiplex said second data stream.

Preferably, the devices of each family are each allocated an identifier which has at least a common portion for all the devices of a family, the common portion for the first family being different from said common portion for the second family, for use in coordinating processes performed by the devices of each family in controlling the demultiplexing device to demultiplex a respective data stream.

The apparatus may preferably further comprise at least one remultiplexing device for remultiplexing each of said at least two data streams for recording.

The signal received and transmitted may comprise content data, administrative or control data, or combinations thereof.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described; herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Materials

The invention consists of proprietary equipment, a private network system using the equipment, and methods for secure transmission of audio and video data using the equipment.

In one embodiment, the equipment consist of a proprietary, dedicated set-top box containing off-the-shelf Motorola brand microprocessor switches, running generic ATM (asynchronous transfer mode software), and generically available components capable of sending and receiving audio and video transmissions such as a housing, power supply, video display apparatus of TV quality, video capture apparatus, stereo audio speaker and microphone, input and output devices such as a mouse and printer, input and output jacks or ports including a telephone jack and up to nine or ten USB ports, circuit board, digital RAM memory, and software which provides for the sending and receiving audio and video data, including advanced compression-decompression (CODEC) algorithms and multiplexing-demultiplexing (MUX-DEMUX) algorithms.

In an embodiment of the private network system, it consists of regionally located network nodes which are Alcatel ATM boxes having ATM switches therein which provide high capacity network links to a plurality of network nodes and a local T1 interface link to the set-top boxes for the set-up, operation and take-down of each video SVC conference circuit over the pre-purchased T1 capacity from a company such as Quest or Verizon.

In an embodiment of the method of transmission, it consists of:

a first VPI customer initiating a videoconference from their location using the proprietary set-top box to wake up the local regional (first) Network ATM switch;

the first Network ATM switch makes a temporary circuit to a second regional Network ATM switch, which in turn contacts the second customer's Set-Top box with a session code and then hangs up dropping the first private virtual circuit;

the second customer then calls back to the first customer through the Network Nodes with the session code, creating a virtual circuit from the second user to the first user;

upon receiving the call from the second user, the first user's Set-Top box creates the return virtual circuit back to the second user, establishing two unidirectional virtual circuits, over private bulk capacity lines;

Lastly, The ATM switches are configured to use ATM ‘hashing’ as added security with a future option to add a proprietary multi-layered encryption algorithm for enhanced security to the customer's site on the ATM private network.

The VPI network, unlike most videoconference networks, does not use a centralized controller.

Methods

Sustainable Competitive Advantages

The VideoPresence advanced secure videoconferencing system has numerous sustainable competitive advantages.

[ ] TV-quality, full-motion video and high fidelity stereo.

[ ] The first (and only) truly easy-to-use multi-way videoconferencing system. User simply “points and clicks” a wireless mouse to connect, add and disconnect video sites; control pan, zoom and tilt movements of far-end video camera(s); and adjust volume settings or mute the audio.

[ ] Extremely easy multi-way videoconferencing system to purchase, install and use. For the first time, users of videoconferencing do not have to determine bandwidth requirements; or purchase multi-way equipment, bridging or managed services.

[ ] Bridgeless, multi-way video calling feature enables users to connect up to 7 video locations in real-time without an MCU.

[ ] Bridgeless, multicast video calling feature enables users to connect an unlimited number of video conference locations in real-time.

[ ] Sidebar™ permits participants in a group video call to break away into a private videoconference, and later return to the group videoconference in real-time, without the need to dial unique numbers, reconnect or utilize a managed bridging service.

[ ] Digital storage feature that enables a video user at any video location to digitally store up to 24 hours of a selected full-resolution video session for future playback, indexing, and searching of the video and audio content.

The apparatus facilitates a multi-way conference of up to seven users or a broadcast conference, from a single point, to hundreds (or thousands) of end points.

All controls, including call set up, are displayed on the video monitor and controlled by a “point and click” action of the wireless mouse. The mouse interface removes the need for a complex “channel changer” and allows for a simplified user interface. Placing a call is simply a few mouse clicks away. Responses are immediate, in contrast to the usual time associated with video over IP or ISDN.

The apparatus (videoconferencing platform) offers a host of advanced features. The system allows for a multi way call to be broken up into two or even three individual conferences, or conversely participants in existing conferences can form up into a single large conference. This capability has been refined even further such that it can break out a sidebar session and when completed, return to the main conference with only two mouse clicks.

There is no need for conference attendants or managed services to arrange and set up multi-site video calls. Whenever the user clicks the wireless mouse using auto answer or reassembly during a Sidebar® session, video sites are connected into a videoconference in less than 100 milliseconds.

The freedom to set up multi-way calls anytime is inherent in the system. There is no conference bridge to install, manage, schedule, pay for, or lease. The system offers a genuine customer driven and spontaneous approach to video conferencing. Not all conferences can be scheduled, especially emergencies. The scheduling element has been removed from the user experience. In doing so, the cost of the actual conference bridge was removed but more significantly, the cost of the port was also removed. Many conference bridge providers charge $1 per minute per seat, and in many cases much more. Additionally, conferences placed through a conference bridge are typically limited to a very slow 128 k bits/second with considerable delay and low picture quality.

The system offers up to 24 hours of on board recording. The calls can also be private. A button can be simply clicked and no one on the call will be able to record the call. The ONLY way the call can be recorded is if ALL of the participants wish (or allow) it recorded.

Call accounting is done in a similar way as the cell phone industry is operated. Minutes of Use are sold and used. Balances and billing summaries are always available on a secure web site. All usage is tracked by a patented Real Time billing system and is completely automated.

Interactive, real-time collaboration of spreadsheets, whiteboards, presentations, and documents enhances information exchange among work teams. In addition to standard video or audio conferencing, high resolution companion displays showing digitally displayed material is planned for future release. The set-top box is capable of receiving, displaying, and transmitting, high-resolution images from a laptop computer or video projector to the far end. This feature enables sharing presentations, drawings, sketches, spreadsheets, or other documents in real-time to meeting participants. A second local display such as a computer monitor can simultaneously display a presentation image while the interactive videoconference session is in progress. The program host will be able to manipulate images on a local computer, e.g. laptop, and display them to the far end.

The Set Top Box (apparatus) has the processing horsepower to receive, process, and display high definition (HD) signals. This mode has particular applications for customers requiring HD content, such as medical, security monitoring, education and entertainment.

Certain instructional or other applications require very high video frame rates, beyond that of traditional video delivery methods. Examples of this type of application may include a video analysis of a golf swing or a tennis stroke with the assistance of a teaching pro. The apparatus offers the ability to capture very high frame rate video locally for future analysis, playback, or archiving. Real-time broadcasting of very high frame rate information will not be possible, but the ability will be provided to capture and store this locally, with an option to transcode the sequence over our network using a lower frame rate or video resolution.

Routine data hashing to prevent interception of the video and audio signals is provided. Many industrial customers and certain government customers require a higher degree of security not offered today in the marketplace. Accordingly, proprietary multi-layered encryption algorithms are also provided where users requiring enhanced security.

The system is perfectly suited for networked digital signage, messaging, interactive kiosks and real-time promotion of information at the point-of-sale to influence buying decisions. Enhancements for this vertical market sector will combine the capabilities of the Set Top box, including HD capability; unlimited multicasting and streaming video; command and control software; and increased digital storage with a strategic relationship with one or more video monitor companies to offer very compelling products and services for retail stores and shopping malls. Users will have the flexibility and freedom to add or change video content in real time and deliver that content to any number of end-point monitors.

The system is also capable of providing remote monitoring for security purposes, with remote capabilities to obtain very high frame rate storage, local processing, and automated activation of alarms. This service is bundled with a software package to locally screen video content, identify security events, and perform pre-programmed alerting functions based on specific events. In addition, this system will be used for pattern recognition for identification of normal or abnormal visual circumstances, such as license plate data or container identification, and will log both identified and unidentified entries.

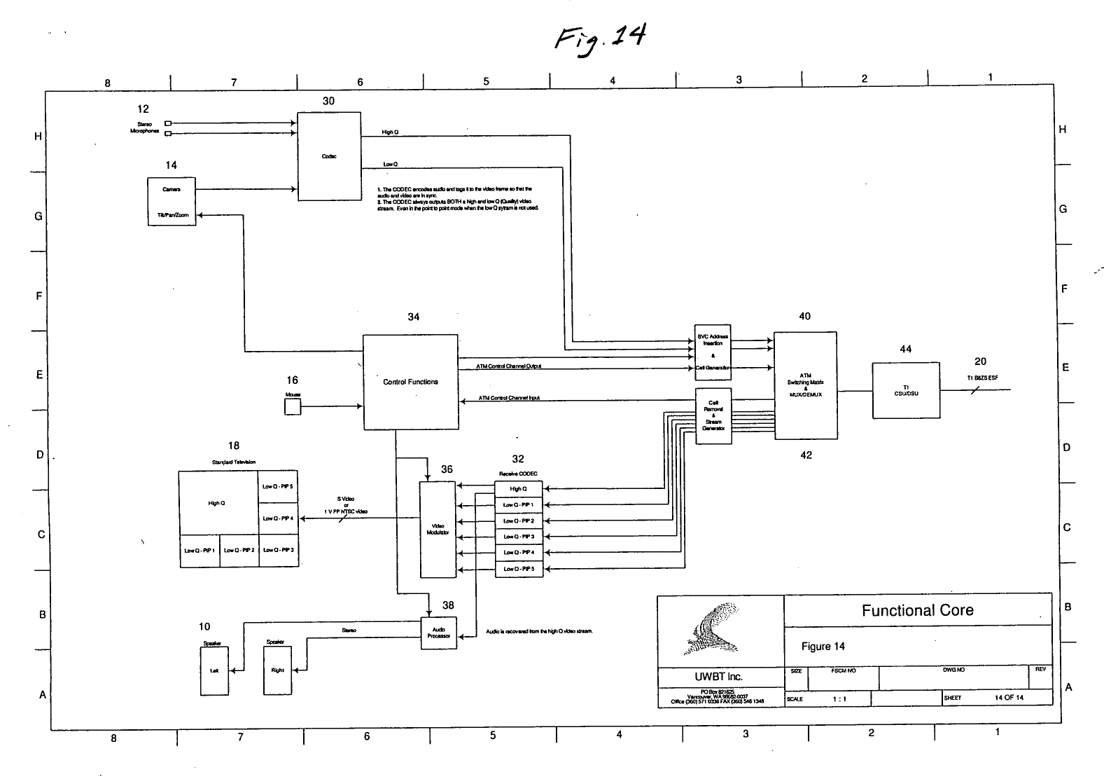

In one preferred embodiment, there is provided: FIG. 14: Functional Core of STB: Diagram shows the internal workings of the set-top-box and the standard peripheral products that connect to the set-top-box.

Numbering System Identification for the functional core.

A. External standard units that interface to the set-top-box

10—Audio stereo speakers

12—Stereo microphones

14—Camera

16—Mouse

18—Standard T.V.

20—Standard T1 (DS1)

B. Internal proprietary interconnecting elements of the set-top-box.

30—CODEC—transmit

32—CODEC—receive

34—Control functions (subset of ATM SW Matrix)

36—Video modulator

38—Audio processor

40—ATM Switch

42—MUX/DEMUX (multiplex/de-multiplex) function of ATM Switch

Description of the Components in the System and the Interaction

The components of the invention are of two distinct types. The first of which are standard off the shelf type i.e., speakers, microphones, cameras, mice, television sets and/or video screens. The second type of components is also standard manufactured parts however the method of design used to connect their functionality together is unique. This set of unique connected components is interconnected with the external standard components to create a one of a kind network operating system. This interaction of external and internal components creates a holistic system in one sense and a very unique set-top-box that controls and supports the video conference system in a second sense.

Interaction: The stereo microphones 10 and the camera 14 connect into the transmit codec 30. The number 18 standard television connects into the video modulator 36. Stereo speakers 10 connect to the audio processor 38. A receive codec 32 connects into the video modulator 36 and to the ATM SW 40. A PC control module connects into the following: mouse 16, camera 14, video modulator 36, audio processor 38 and ATM SW 40. The MUX/DEMUX section of the ATM SW 42 connects to the T1 CSU/DSU 44 which also connects to the T1 which is utilizing the B8ZS/ESF framing protocol on FIG. 14 number 20.

Operating Functionality of the Invention

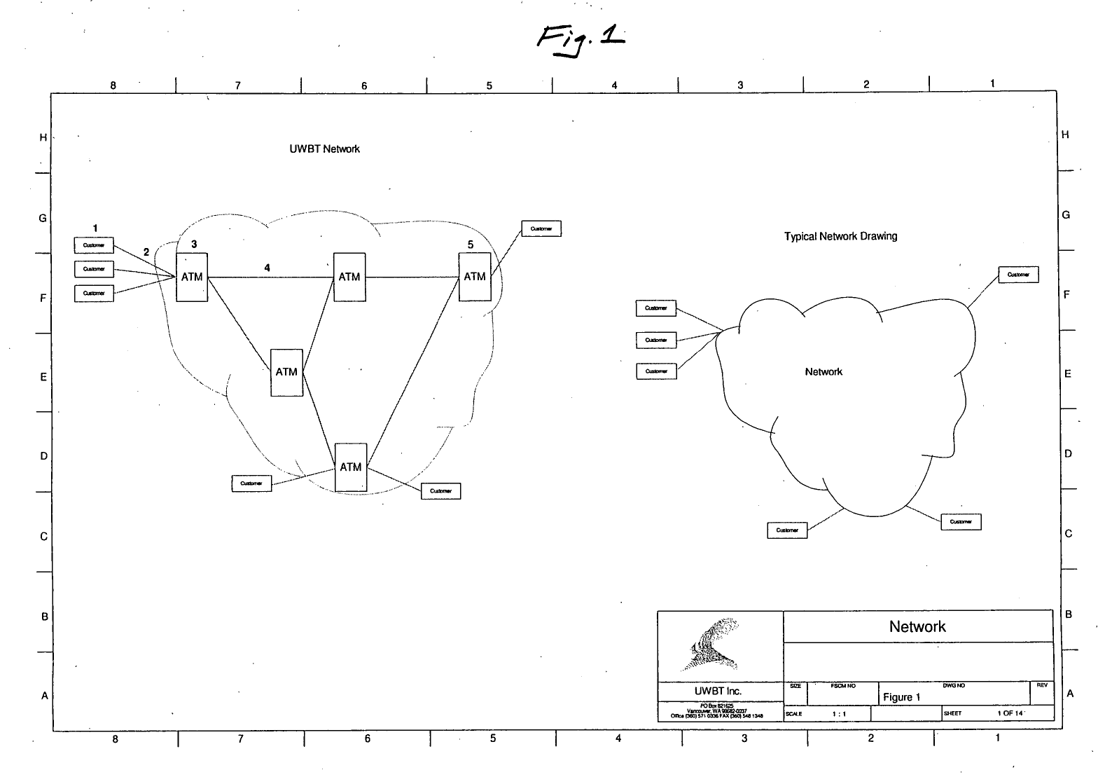

A Video Conferencing System Network (FIGS. 1, 14) that connects together the set-top-box (FIG. 1 element 1) located in each customer location. The network as depicted in FIG. 1 is an integrated ATM Node Network (element 3) designed to configure Switched Virtual Circuits and ATM u4) to critically located ATM Nodes and to the set-top-box (FIG. 1) from the edge location of the network.

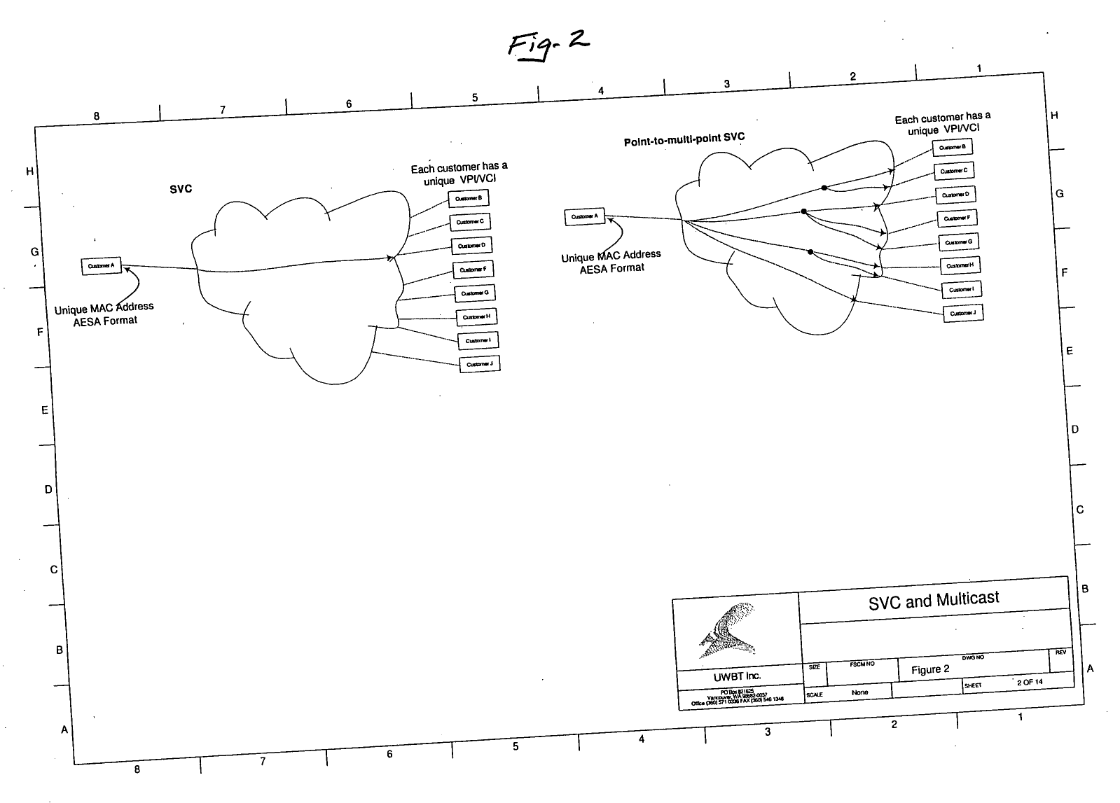

Point to Point Switched Virtual Circuit: Customer A selects an AESA (ATM End System Address) with the mouse (FIG. 2 element 16). This service address is presented to a port on the ATM Switching Matrix (FIG. 14, element 40) within the set-top-box (FIG. 14). This address, along with ATM PNNI V4.0 control codes is forwarded to an ATM Node Switch (FIG. 1. element 3) which creates the best path from the local port to the distant port and establishes a High Quality (Q) video/audio stream, one Low Quality (Q) video/audio stream and one control channel into cells on the virtual circuit between customer A's set-top-box (FIG. 1 element 1) and customer B's set-top-box (FIG. 1, element 5. The “called party” responds by setting up a High Q broadcast SVC to the calling party. The link is established. A High Q video picture would appear on the standard T.V. or video monitor (FIG. 14, element 18) and stereo voice would be heard over the stereo speakers (FIG. 14, element 10).

Point to Multi-point Switched Virtual Circuits: Customer A, B, C, D etc. (FIG. 2) selects an AESA address with the mouse (FIG. 14, element 16) for customer E. This service address is presented to a port on the ATM Switching Matrix (FIG. 14, 40) within the set-top-box (FIG. 14). This address, along with the ATM PNNI V4.0 control codes are forwarded to an ATM Node Switch (FIG. 1, element 3) which creates the best paths to replicate the set up information as directed by the ATM Matrix in the set-top-box. In the multipoint configuration customer E would be transmitting High Q SVC circuits to the multiple customers A, B, C, D, etc. Since SVC's are set up from the host site, the network will route to make the best use of the available resources. In this case if A, B, and C, were in Seattle and D and E were in Washington D.C. only one SVC would be established between Washington D.C with the node switch in Seattle establishing the circuits between the Seattle switches. A SVC would be established between the two locations D and E in Washington D.C. to make the network complete. This setting up of multipoint circuits allows the network to function as a network bridge.

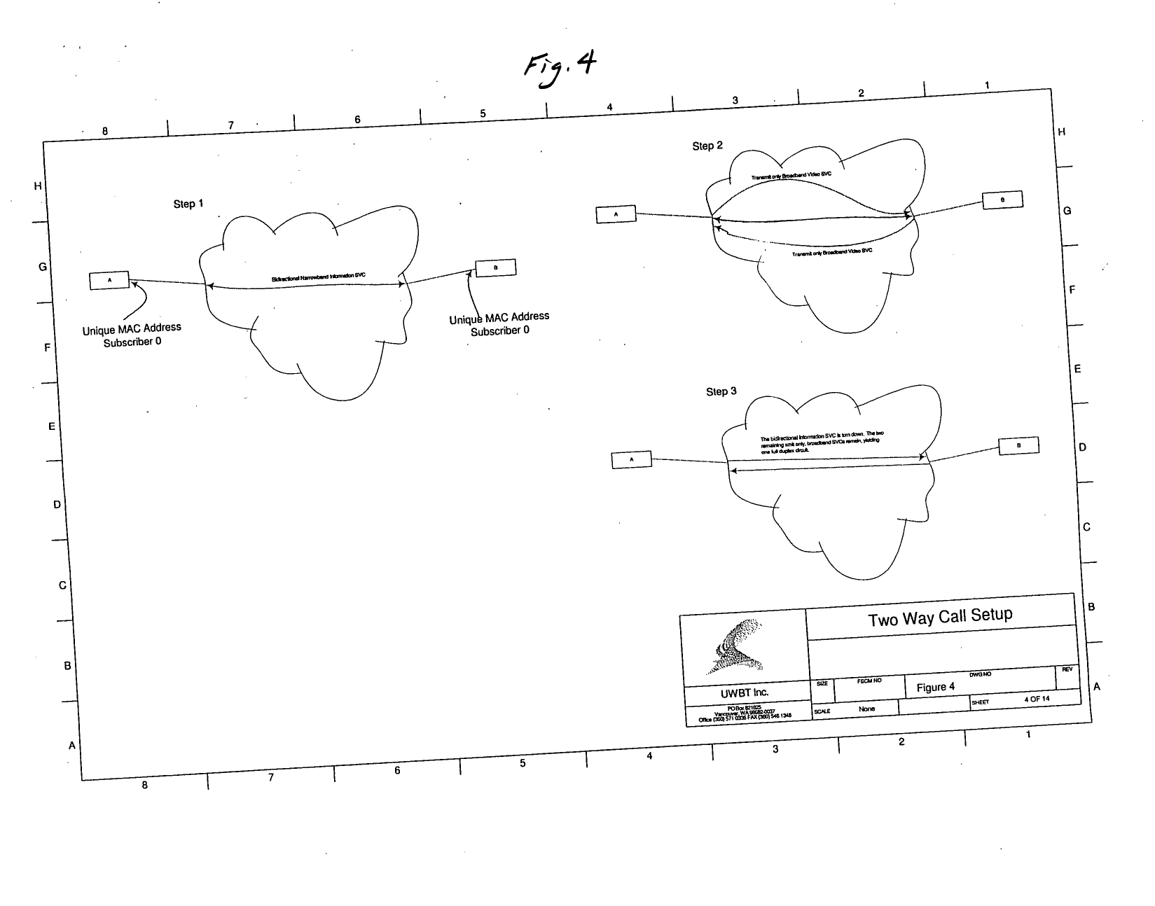

Two Way Call Setup: Customer A (FIG. 4) uses a mouse (FIG. 14 element 16) to select an AESA number which corresponds to a MAC address for customer B. The control channel is pointed at the unique MAC address and subscriber 0. A bidirectional narrowband SVC is established between the control modules (FIG. 14 element 34) inside each set-top-box using the two MAC addresses and subscriber 0. Customers A's information, much like caller ID is transmitted to customer B. This information includes customers A's unique MAC address, participant number, name, and other supporting information. When B's set-top-box rings, B must manually answer (unless set to auto answer). Customer B and customer A exchanges information required for the session and stores the information in the control module (FIG. 14 element 34 Using the information stored in the control module 34, customer B's control module sets up a wideband circuit to customer A's control module 34. In a similar manner, customer A uses the information stored in the control module 34 to establish a high bandwidth circuit to the control module of customer B. Once both circuits are established, there is a transmit circuit established in both directions, yielding a full duplex wideband circuit suitable for video. The service of the narrowband information SVC is no longer required and is torn down. The resultant circuit is a bidirectional broadband circuit.

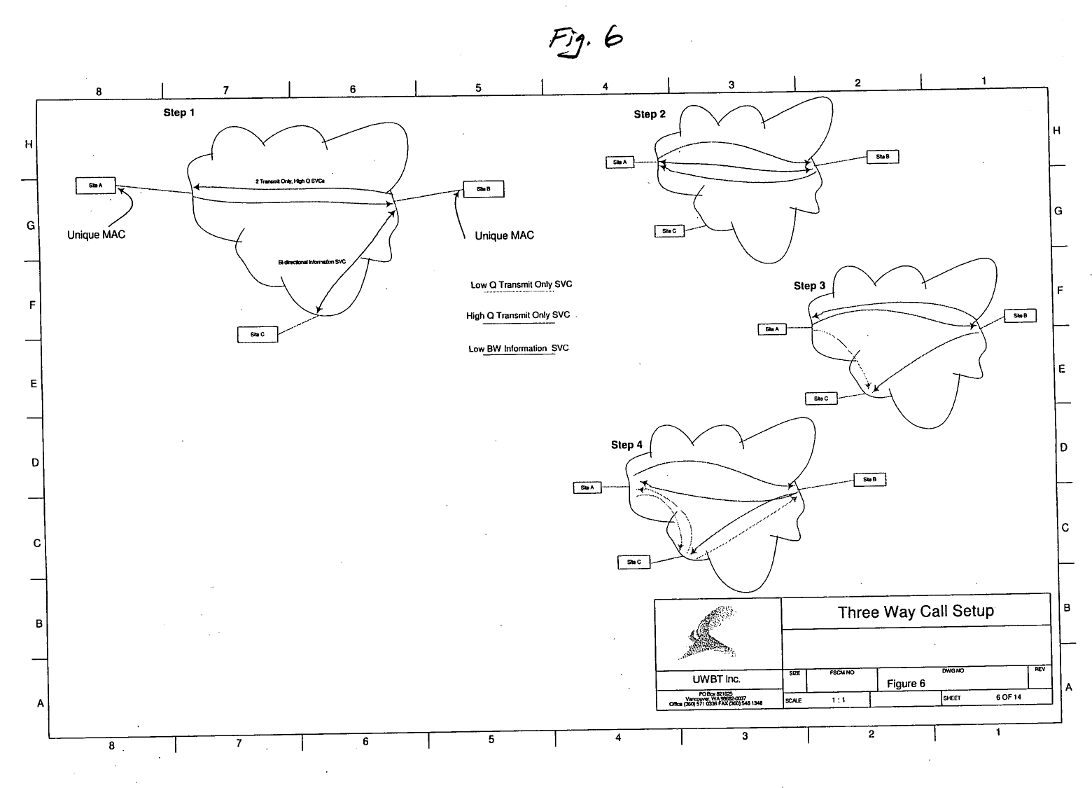

Three Way Call Setup: Customer A and B (FIG. 6) are in an existing conference as described in the Two Way Call Setup. A new call is initiated by customer C (FIG. 6) by selecting a stored MAC address with the mouse. A bidirectional narrowband SVC is established between the control modules (FIG. 14 element 34) inside each set-top-box. If C is calling B, information much the same as caller ID is transmitted to B. This information includes customers C's unique MAC, name, participant number and other supportive information. The controllers in C and B exchange information. In this call set up scenario, customer B sends the information for all locations on the call, specifically A and B's information. In this case the information shared is for 2 sites however the system is designed to include up to 5 other sites. Since customer B was the site the customer C called into, customer B controller (FIG. 14 element 34) uses the stored information in the control module 34, to establish a High Q multicast SVC to customer B's controller 34. All other sites call customer C with a Low Q SVC. Next customer C calls each of the existing sites using the information it just received from customer B. In every case the call is a Low Q SVC. The Low Q SVC shows up on each of the participants A and B's screens as an additional PIP (Picture in Picture) display (FIG. 14 element 18).

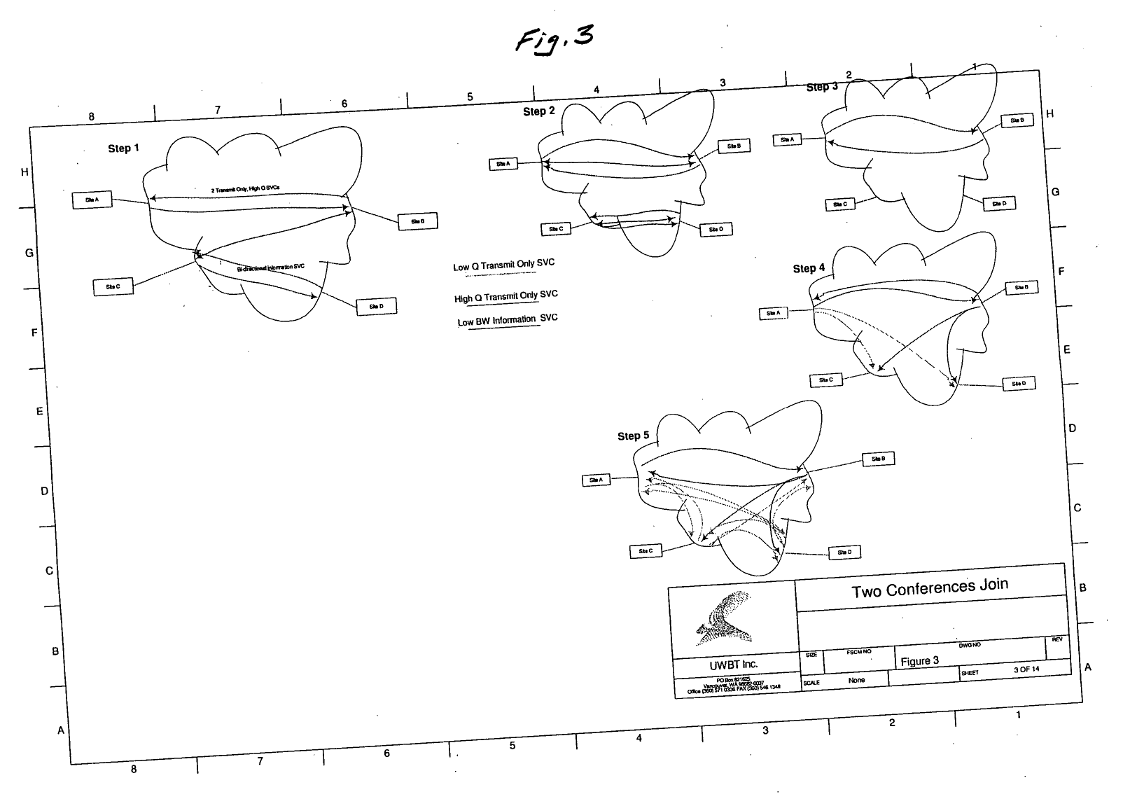

Two Conferences Join: Customer A and B (FIG. 3) are in conference and customer C and D (FIG. 3) are in conference. Customer C uses a mouse (FIG. 14 element 16) to select the address of customer B. Customer C's information much the same as caller ID is transmitted to customer B controller (FIG. 14 element 34). When the set top box rings, customer B must answer manually (unless on auto answer). Customer C's controller sends caller ID information stored in the controller on all customers involved in the existing conference. Customer B and Customer C share the information it received from each other to all other conferees on the existing conference. Customer C and D hang up from their existing call. Since customer B is the site that customer C called into, customer B's stored control information calls everyone on C's conference with a High Q multicast SVC. All other sites call C with a Low Q SVC. In each case the call is an ADD to any existing SVC's. Customer B actually calls everyone in joining the conference with a High Q SVC. Next, C and D call each of the existing sites using the information it just received from B. In every case the call is a low resolution SVC. The Low Q SVC shows up on each participants screen as an additional PIP (Picture in Picture) display.

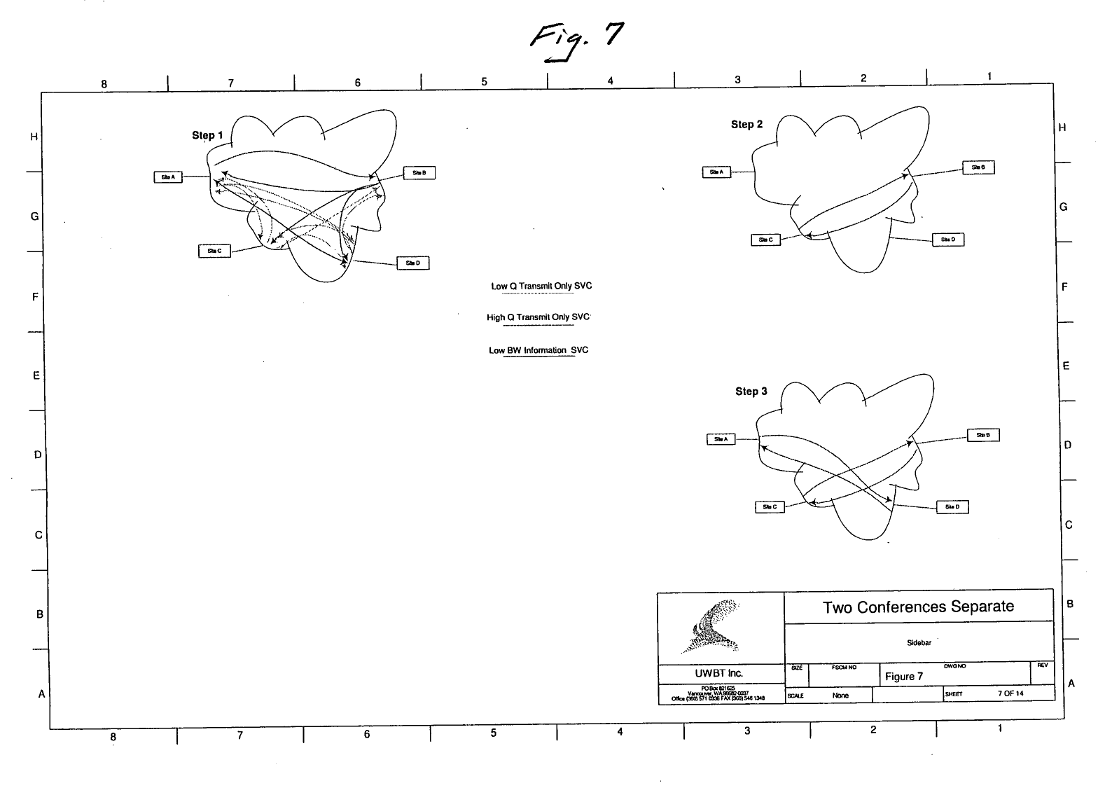

Sidebar Conference: Customers A, B, C and D (FIG. 7) are in an existing conference. Customer A and D wish to leave and have a sidebar conference. If customer D accepts, information is exchanged on the information SVC and stored in the control module (FIG. 14 element 34). Customer A and D now hang up on the current call leaving customers B and C in the call. Customers B and C are now in a two way call situation and establish a High Q circuit with each other. Customer B and C controller (FIG. 14 element 34) retains the addresses of the customer sites A and D that have left the conference. A new conference is established between customers A and D from the information stored in the customers control module. The addresses of the customers C and D in the previous conference are still retained in the control module memory. When the customers from either sidebar conference wish to rejoin, either conference may request that the conference rejoin by clicking on the mouse and selecting any of the addresses on the other customers in the previous conference. When this occurs, a ring will occur on the called party's set top box and if it is answered the rejoin process will happen as described in the “Two Conferences Joining” in the prior paragraph.

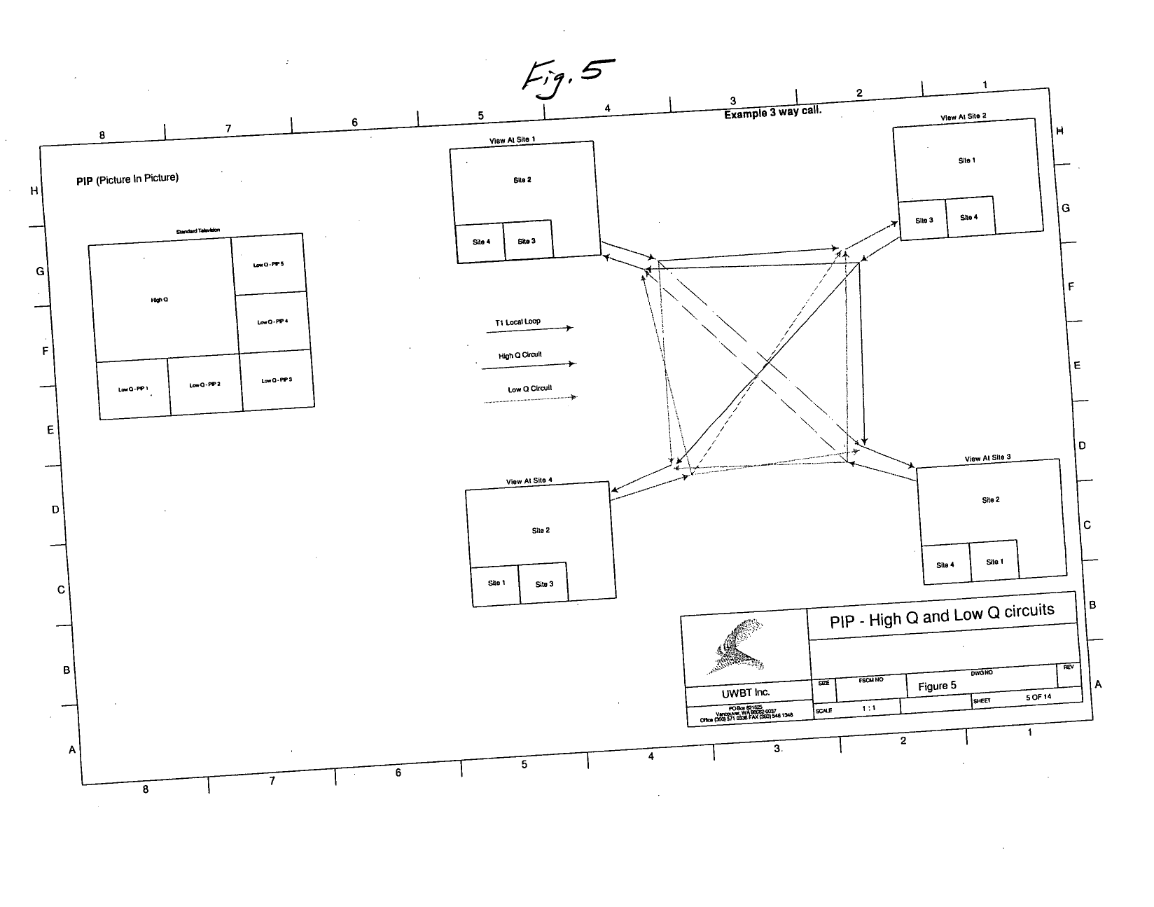

PIP—High Q and Low Q Circuits: PIP (Picture In Picture) (FIG. 5) allows for multiple views to be displayed on an inexpensive television screen (FIG. 5). In this system, each customer can have one High Q circuit (about 800 kbits/sec) and up to 5 Low Q circuits (about 45 kbits/sec) displayed on the screen. The customer has the option of displaying any of the video streams from other customer conferee sites as High Q or Low Q displays. Therefore, each site must have access to all High Q and all Low Q streams.

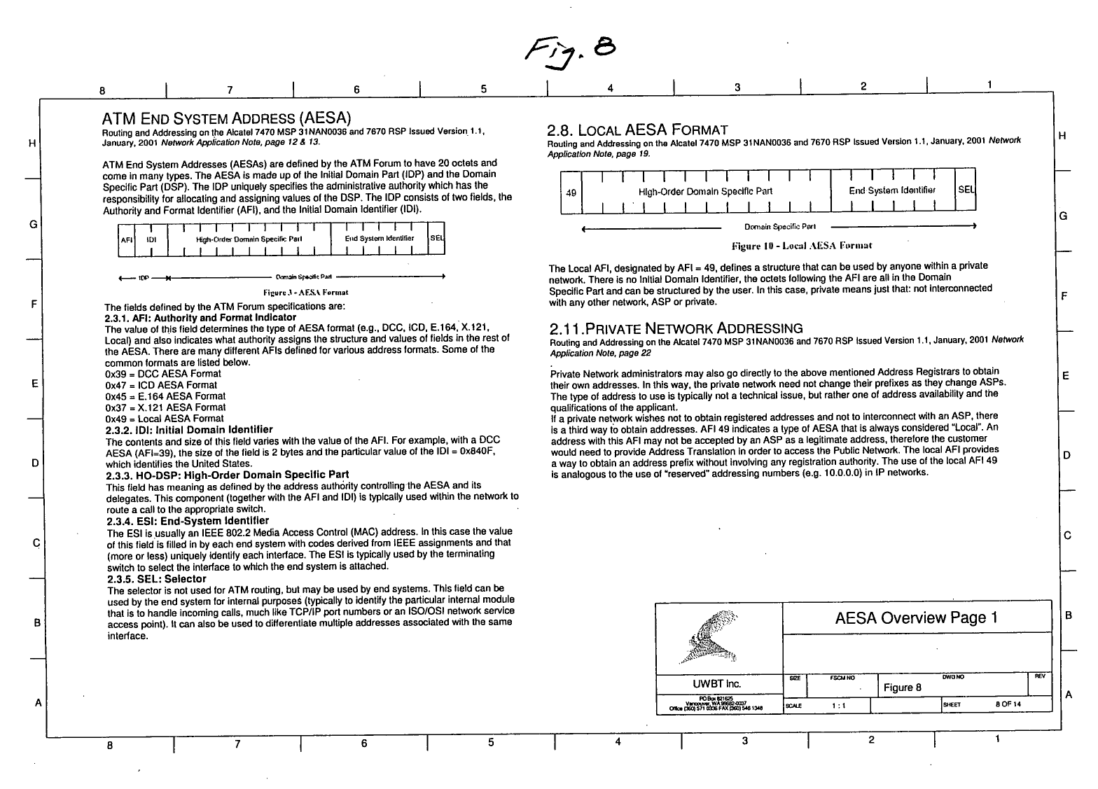

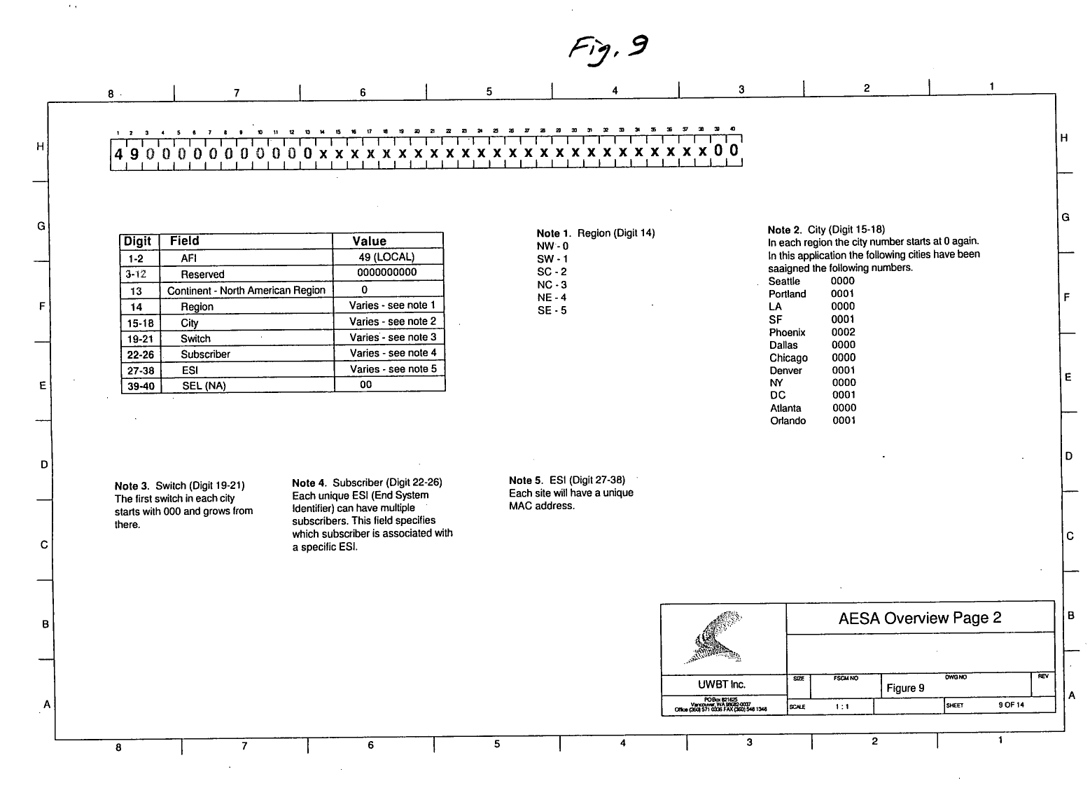

FIGS. 8 and 9 describe the details of ATM End System Addressing (AESA), including regional codes, city codes, switch codes, subscriber codes, and site codes.

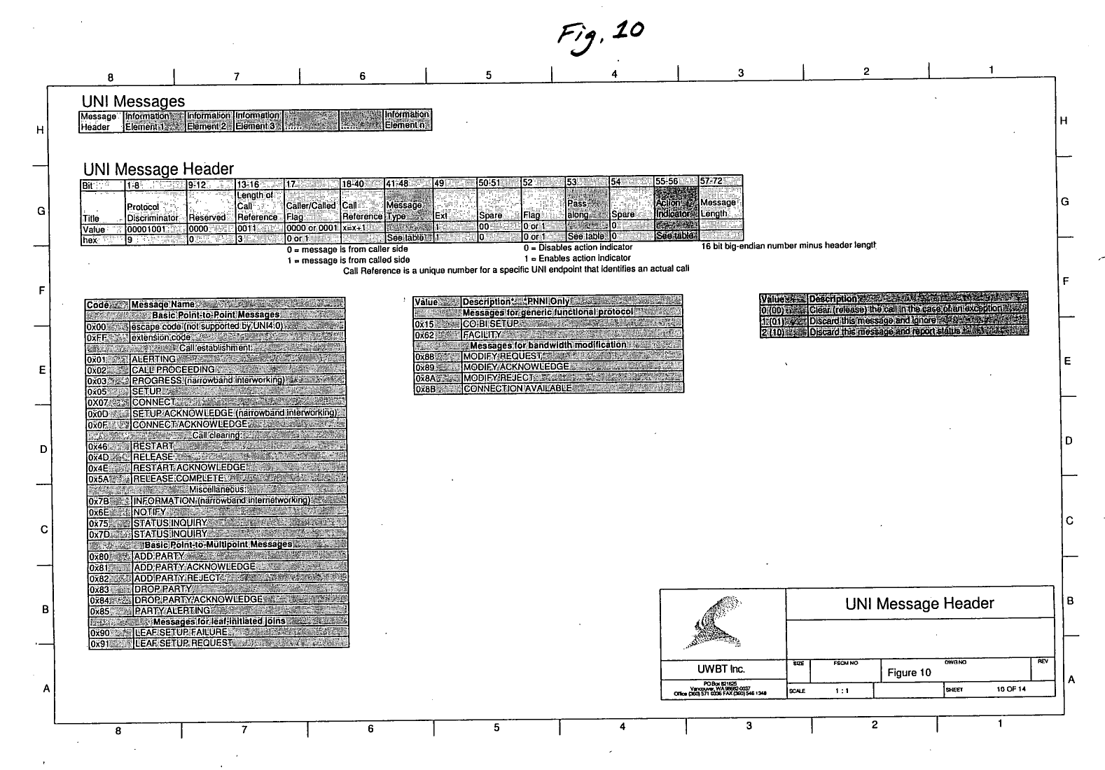

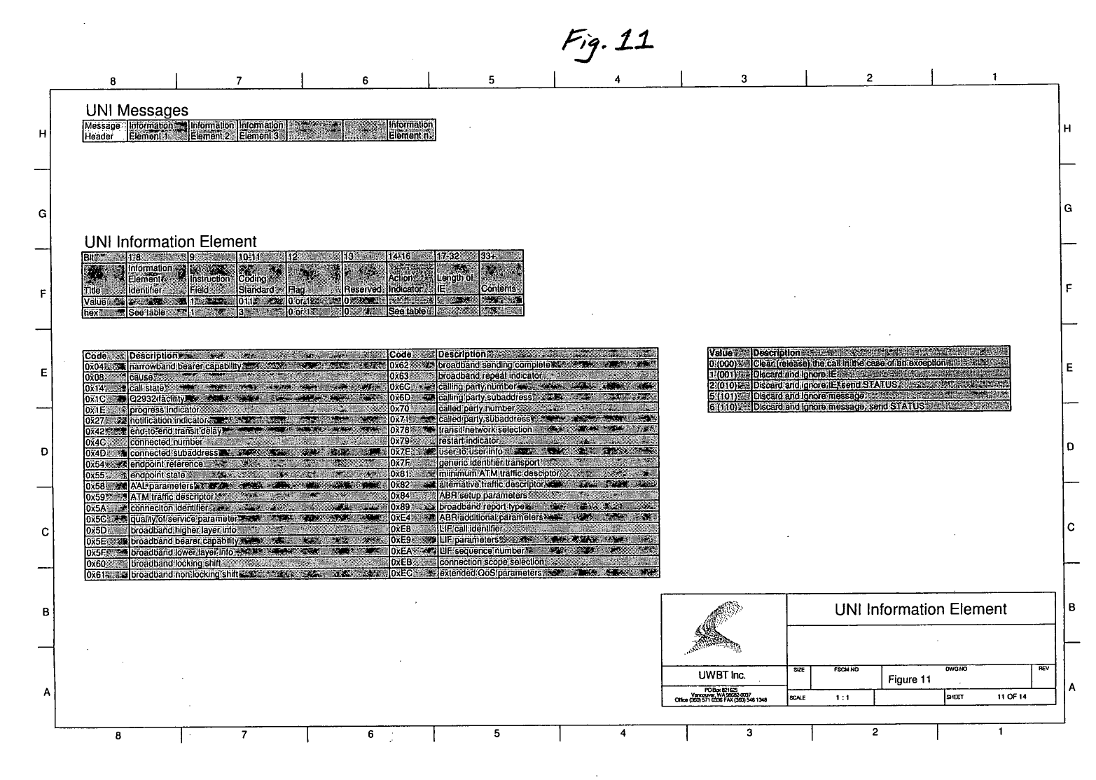

FIGS. 10 and 11 show a User Network Interface (UNI) Message Header, and UNI Information Elements.

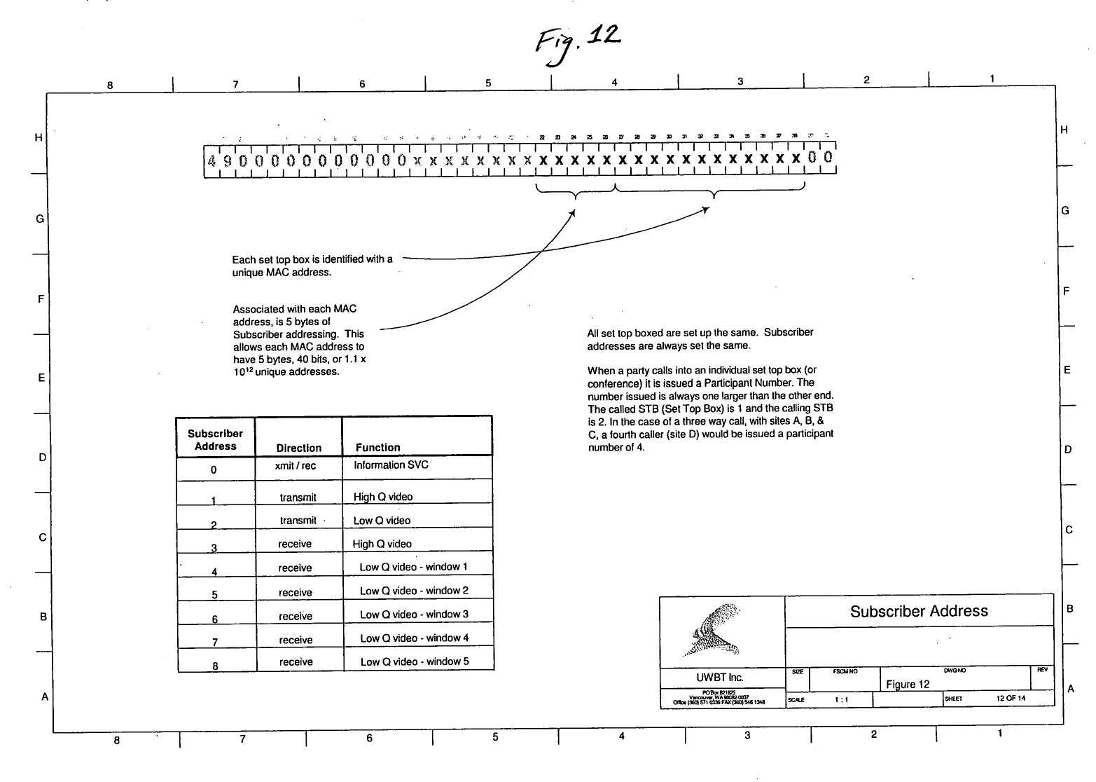

FIG. 12 describes how each Set Top Box is identified with a unique MAC address. Associated with each MAC address is 5 bytes of Subscriber addressing.

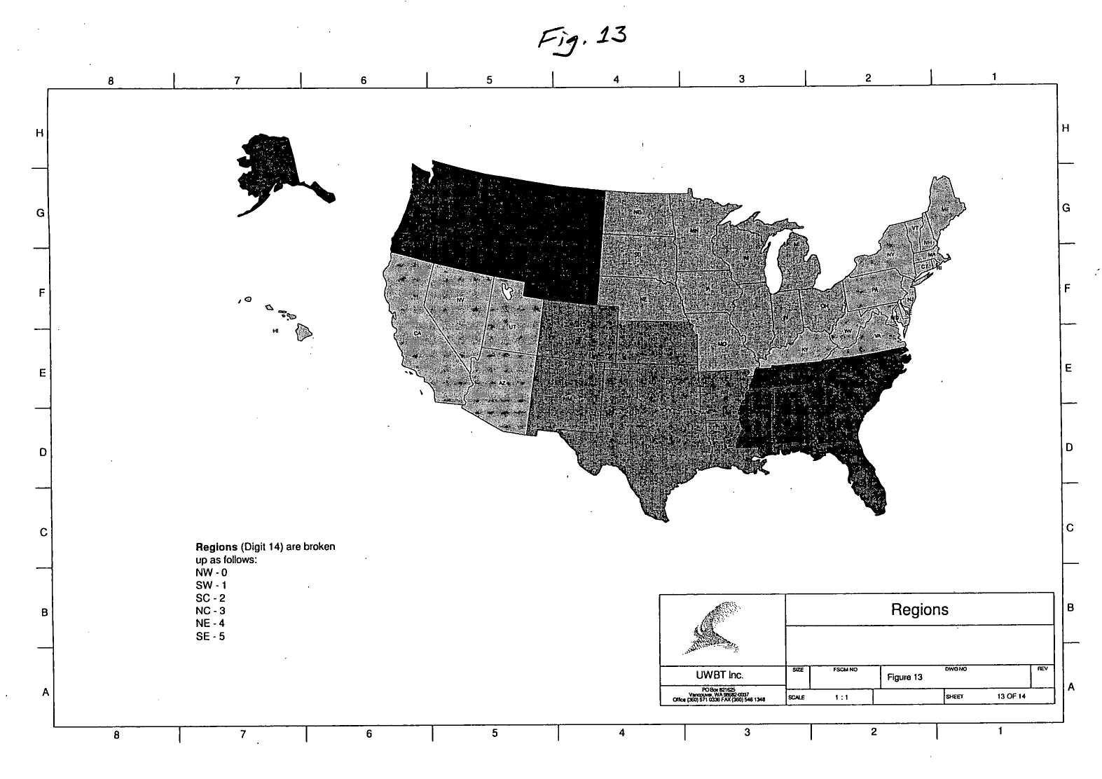

FIG. 13 shows the regional breakdown of region codes at Digit 14.

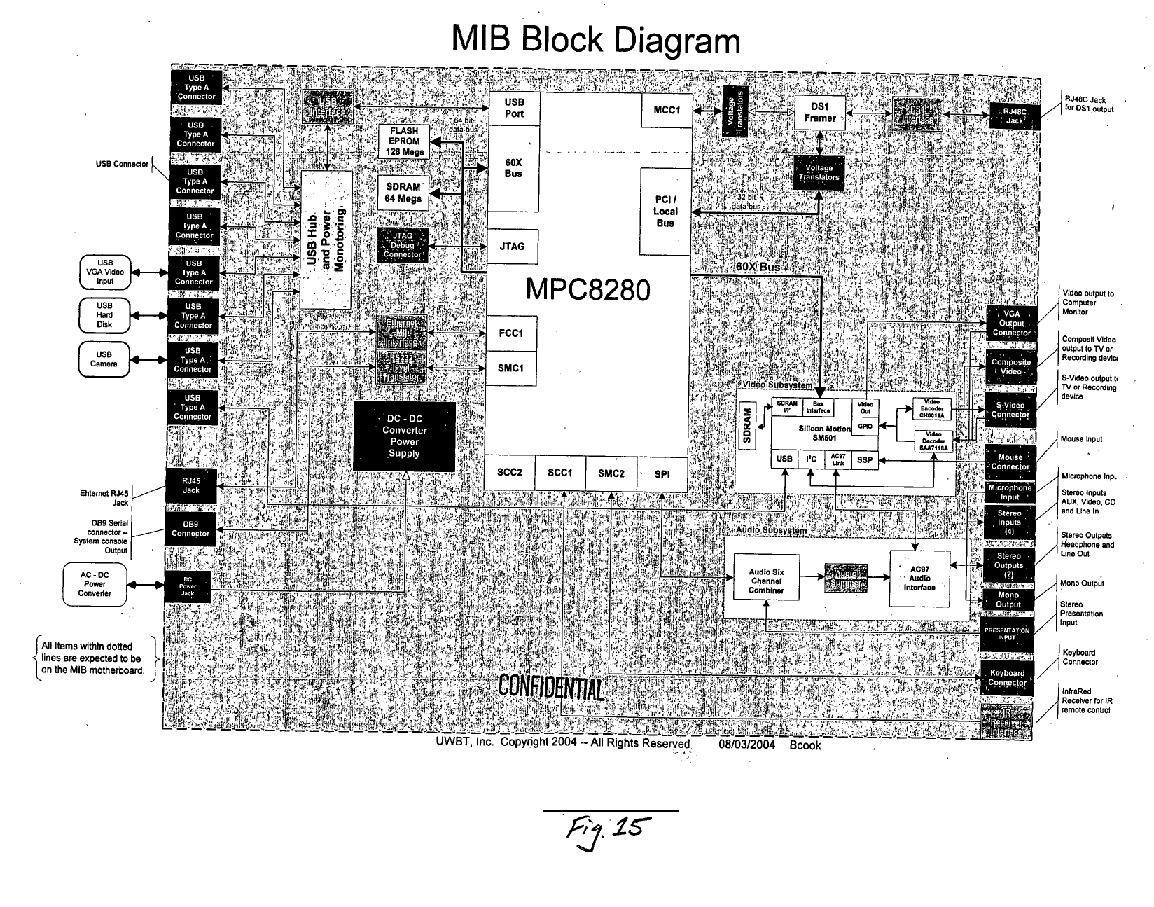

FIG. 15 is the MIB Block Diagram and describes the control function (34) in FIG. 14 in more detail. Note the integration of the 8280 processor which has been specialized with Ethernet, SDRAM, Flash EPROM, multiple USB connectors, HUB, and interface, video subsystem, audio subsystem, rs232 connectors, and T1 communication ports, etc. By putting ATM (LINUX) software on an 8280 processor, the functionality of an ATM Network Switch is achieved in a desktop device. Further by connecting a video stream thru the 8280 processor, it has avoided the need to use multiple processors. This combination of audio and video chipsets on one card, i.e. integrated directly on the 8280 communication processor, is believed to be a unique feature of the present invention. Another unique feature includes the combination of USB ports (input) and T1 communication ports on the same Set Top Box. This provides the T1's 1.544 Mb outputs vital to a functional, user friendly system. Lastly, the software package included herein allows for the collection, processing, and detection of error events out of the microprocessor, so that true quality audio and video conferencing is achieved.

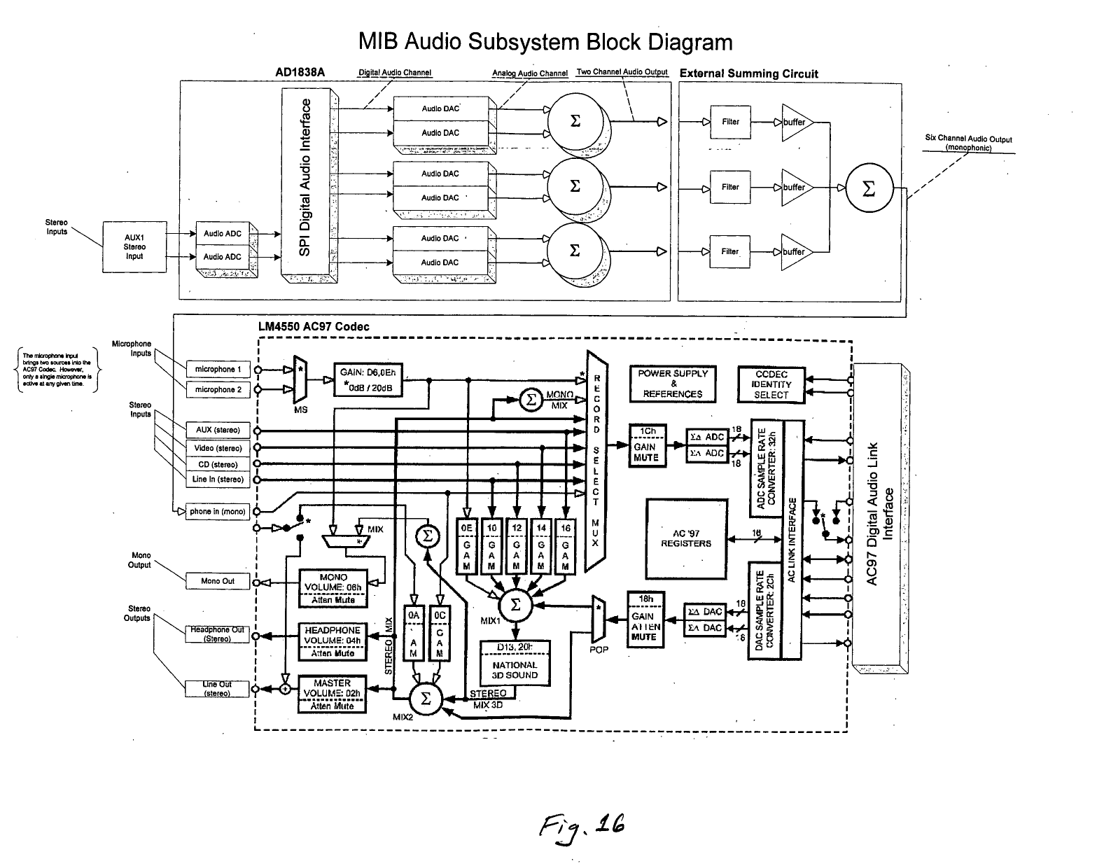

FIG. 16 shows the MIB Audio Subsystem Block Diagram, including the AD1838A high performance single chip CODEC, the digital audio interface, external summing circuit, and the LM 4550 AC97 high quality Multi-Channel Audio Codec with stereo headphone amplifier, sample rate conversion and national 3D sound.

What is claimed is:

1. An apparatus for providing private network videoconferencing services for two or more customers, which comprises:
a circuit board having a housing, digital RAM memory, and a power supply connected thereto;
a microprocessor, connected to the circuit board and having ATM (asynchronous transfer mode) software loaded thereon;
video display apparatus of TV quality operatively connected to the housing circuit board;
video capture apparatus operatively connected to the circuit board;
stereo audio speaker operatively connected to the circuit board;
microphone operatively connected to the circuit board;
one or more input devices operatively connected to the circuit board;
one or more output devices operatively connected to the circuit board;
input and output jacks or ports including a telephone jack, up to nine or ten USB ports, and a T1 communication port; and,
software which provides for the sending and receiving audio and video data, including advanced compression-decompression (CODEC) algorithms and multiplexing-demultiplexing (MUX-DEMUX) algorithms.

2. The apparatus of claim 1, wherein the video display apparatus of TV quality produces at least 525 lines per field and 800 pixels per line at 30 frames per second over a T1 connection.

3. The apparatus of claim 1, wherein hi-resolution video can be changed from one site to another.

4. The apparatus of claim 1, further comprising a combined audio & video chip set that integrates directly into a communication processor.

5. The apparatus of claim 1, wherein one of the input devices is a USB ports and one of the output devices is a T1 communications port.

6. The apparatus of claim 1, wherein the ATM software includes a software package that collects processing data depicting the through-put and error status of the apparatus.

7. A private videoconferencing network system, which comprises:
one or more regionally located network nodes which are Alcatel ATM boxes having ATM switches therein which provide high capacity network links to a plurality of network nodes and a local T1 interface link to two or more remote set-top boxes for the set-up, operation and take-down of a video SVC conference circuit over pre-purchased T1 capacity from a telecommunication carrier company.

8. The system of claim 7, wherein the remote set-top boxes have video display apparatus of TV quality produces at least 525 lines per field and 800 pixels per line at 30 frames per second over a T1 connection.

9. The system of claim 7, wherein the remote set-top box comprises means for changing hi-resolution video from one site to another.

10. A method of videoconference transmission, which comprises:
a first user initiating a videoconference from their location using a set-top box to wake up a local regional (first) Network ATM switch, identifying a unique private network source address of said caller and a unique private network destination address of a call recipient;
the first Network ATM switch making a temporary circuit to a second regional Network ATM switch, which in turn contacts a second user's Set-Top box with a session code and then hangs up dropping the first private virtual circuit;
the second user making a return call using the second user's Set-Top box back to the first user through the Network Nodes with the session code, creating a virtual circuit from the second user to the first user;
upon receiving the call from the second user, the first user's Set-Top box creates a return virtual circuit back to the second user, establishing two unidirectional virtual circuits and validating the source address and destination address of the videoconference users, wherein the method of transmission occurs over private bulk capacity lines and wherein the ATM switches are configured to use ATM ‘hashing’ as a security feature.

11. The method of claim 10, wherein the set-top box comprises video display apparatus of TV quality produces at least 525 lines per field and 800 pixels per line at 30 frames per second over a T1 connection.

12. The method of claim 10, wherein the set-top box comprises means for changing hi-resolution video from one site to another.
